(19) United States
(12) Patent Application Publication
(10) Pub. No.: US 2010/0028796 A1
(43) Pub. Date: Feb. 4, 2010

(54) MAGNETIC CARRIER AND TWO-COMPONENT DEVELOPER

(75) Inventors: Kunihiko Nakamura, Gotemba-shi (JP); Hiroyuki Fujikawa, Yokohama-shi (JP); Koh Ishigami, Mishima-shi (JP); Nozomu Komatsu, Mishima-shi (JP); Chika Inoue, Noda-shi (JP); Tomoko Endo, Odawara-shi (JP); Yoshinobu Baba, Yokohama-shi (JP); Takayuki Itakura, Mishima-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/534,947

(22) Filed: Aug. 4, 2009

(30) Foreign Application Priority Data
Aug. 4, 2008 (JP) 2008-200642

(51) Int. Cl. G03G 9/08; G03G 9/107; G03G 9/113

(52) U.S. Cl. 430/110.3; 430/111.3; 430/111.35

(57) ABSTRACT

A magnetic carrier and two-component developer are provided alleviating coarse images, fogging when printing is done after a copier body is left standing for one week in a high temperature and high humidity environment and carrier adhesion after extensive operation in a low image ratio. The magnetic carrier includes magnetic carrier particles including porous magnetic core particles and a resin, wherein in a mercury intrusion method applied to the porous magnetic core particles, a pore diameter in which a differential pore volume in the specific pore diameter range becomes maximum is in a specific range, and when the maximum value of a differential pore volume in the specific pore diameter range is defined as P1 and the maximum value of a differential pore volume in the specific pore diameter range is defined as P2, P1 is in a specific range and the ratio P2/P1 is in a specific range.

### BACKGROUND OF THE INVENTION

1. Field of the Invention

The present invention relates to a magnetic carrier and a two-component developer used for an electrophotographic method and an electrostatic recording method.

2. Description of the Related Art

In an electrophotographic method, a step of developing an electrostatic image forms a toner image and attaches a frictionally charged toner onto the electrostatic image using coulomb force with the electrostatic image. The developer for developing the electrostatic image using the toner includes a one-component developer using a magnetic toner obtained by dispersing a magnetic material in a resin and a two-component developer which is used by mixing a non-magnetic toner with a magnetic carrier.

The latter is preferably used especially for a full-color copying machine for which high image quality is demanded or a full-color image forming apparatus such as a full-color printer.

Recently, also in a full-color image forming apparatus, photographic image quality and a reduction in power consumption have been demanded than ever before. For the photographic image quality, the uniformity (non-coarseness) and high image quality over a long period of time of a half-tone image are required than ever before.

Many studies have been made in order to solve the above problems, and there is proposed a resin-filled type magnetic carrier in which a resin is filled in a ferrite core having pores (see Japanese Patent No. 4001606 and Japanese Patent No. 4001609).

According to these proposals, if the magnetic carrier has a low density, the deterioration of an image may be suppressed to some extent.

However, when a copier in which a temperature control heater (drum heater) of a drum unit used to reduce a temperature change in the photoconductive properties of the image forming drum surface is removed in order to reduce the power consumption, is allowed to stand for one week in a high temperature and high humidity environment (a temperature of 30° C. and a humidity of 80% RH) and printing is carried out, a phenomenon (fogging) occurred in which the frictional charge quantity of the toner was decreased and the toner was adhered to a non-image region to deteriorate the toner image and coarseness (or a coarse image) occurred in some cases.

In addition, when 50,000 sheets were printed out in a low image ratio (an image ratio of 1%), and a damaged magnetic carrier was adhered onto the image in some cases. Further, when an image in which a half-tone and a solid portion are adjacent to each other was printed out in a high temperature and low humidity environment (a temperature of 23° C. and a humidity of 5% RH), a phenomenon (blank areas) occurred in which the concentration of the half-tone image is decreased in some cases.

A proposal has been made in which the carrier performance of the resin-filled type magnetic carrier was improved by controlling the ratio between the total volume of the pores and the total volume of the pores and voids of the carrier core particles, measured by a mercury intrusion method. The pore refers to a minute hole present in the carrier core particle and the void refers to the gap between the carrier core particles measured by a mercury intrusion method. The control of the above ratio is effective in maintaining high resistance when high voltage is applied (Japanese Patent Application Laid-Open No. 2007-218955).

In addition, a magnetic carrier has been proposed in which the void diameter of a carrier core measured by a mercury intrusion method was controlled, the magnetic carrier becomes near to a true sphere, the ear rise of the magnetic carrier become soft, and coarseness and initial carrier adhesion were in a good state (Japanese Patent Application Laid-Open No. 2007-163673).

However, no improvement was made for the carrier adhesion after a low image ratio durability test, the fogging after being allowed to stand in a high temperature and high humidity environment and the Blank areas in a low humidity environment by only defining and controlling the ratio between the total volume of the pores and the total volume of the pores and voids and the void diameter, as described above.

Even in all the proposals as described above, a magnetic carrier and a two-component developer, in which the coarseness is alleviated and the fogging, the carrier adhesion and the Blank areas are sufficiently alleviated, have not been obtained, and further improvement is demanded.

### SUMMARY OF THE INVENTION

An object of the present invention is to provide a magnetic carrier and a two-component developer which can alleviate coarseness of a toner image, alleviate fogging when printing is carried out after an image forming apparatus body is allowed to stand for one week in a high temperature and high humidity environment, and reduce carrier adhesion after a low image ratio durability test.

Further, an object of the present invention is to provide a magnetic carrier and a two-component developer in which blank areas in a low humidity environment are alleviated.

As a result of earnest studies made by the present inventors, it have been found that it is possible to alleviate coarseness and fogging when printing is carried out after a copier body is allowed to stand for one week in a high temperature and high humidity environment and to reduce carrier adhesion after a low image ratio durability test by controlling the pore diameter distribution of porous magnetic core particles.

The present invention relates to a magnetic carrier including magnetic carrier particles composed at least of porous magnetic core particles and a resin, wherein, in a mercury intrusion method applied to the porous magnetic core particles, a pore diameter in which a differential pore volume in a pore diameter range of 0.10 μm or more to 3.00 μm or less is maximum is 0.80 μm or more and 1.5 μm or less, and when a maximum value of a differential pore volume in a pore diameter range of 0.80 μm or more and 1.50 μm or less is defined as P1 and a maximum value of a differential pore volume in a pore diameter range of 2.00 μm or more and 3.00 μm or less is defined as P2, P1 is 0.05 ml/g or more and 0.50 ml/g or less and a ratio P2/P1 is 0.05 or more and 0.30 or less.

Further, the present invention relates to a two-component developer including a magnetic carrier and a toner, wherein the magnetic carrier includes magnetic carrier particles composed at least of porous magnetic core particles and a resin, and in a mercury intrusion method applied to the porous magnetic core particles, a pore diameter in which a differential pore volume in a pore diameter range of 0.10 μm or more and 3.00 μm or less is maximum is 0.80 μm or more and 1.5 μm or less, and when a maximum value of a differential pore volume in a pore diameter range of 0.80 μm or more and 1.50 μm or less is defined as P1 and a maximum value of a differential pore volume in a pore diameter range of 2.00 μm or more and 3.00 μm or less is defined as P2, P1 is 0.05 ml/g or more and 0.50 ml/g or less and a ratio P2/P1 is 0.05 or more and 0.30 or less.

The present invention can alleviate coarseness and fogging when printing is carried out after an image forming apparatus body is allowed to stand for one week in a high temperature and high humidity environment and can reduce carrier adhesion upon printing an image having a low image ratio. Further, the present invention can also alleviate blank areas in a low humidity environment.

Further features of the present invention will become apparent from the following description of exemplary embodiments with reference to the attached drawings.

### BRIEF DESCRIPTION OF THE DRAWINGS

FIG. 1 is a schematic view of a surface modification apparatus which can be applied in the present invention.

FIG. 2 is a view illustrating an example of a pore diameter distribution measured by a mercury intrusion method applied to the porous magnetic core particles in the present invention.

FIG. 3 is an enlarged view illustrating an example of a pore diameter distribution measured by a mercury intrusion method applied to the porous magnetic core particles of the present invention.

FIGS. 4A and 4B are schematic views of a measurement apparatus of the breakdown electric field intensity of the porous magnetic core particles in the present invention.

### DESCRIPTION OF THE EMBODIMENTS

The magnetic carrier of the present invention has at least porous magnetic core particles and a resin.

In the porous magnetic core particles, the pore diameter, where the differential pore volume in the pore diameter range of 0.10 μm or more and 3.00 μm or less in the mercury intrusion method is maximum, is in the range of preferably 0.80 μm or more and 1.5 μm or less and more preferably 0.90 μm to 1.40 μm.

In addition, when the maximum value of the differential pore volume in the pore diameter range of 0.80 μm or more and 1.50 μm or less is defined as P1 and the maximum value of the differential pore volume in the pore diameter range of 2.00 μm or more to 3.00 μm or less is defined as P2, P1 is preferably 0.05 ml/g or more and 0.50 ml/g or less and more preferably 0.10 ml/g or more and 0.45 ml/g or less, and the ratio P2/P1 is 0.05 or more and 0.30 or less and more preferably 0.10 or more and 0.25 or less.

In the mercury intrusion method, the pressure applied to mercury is changed and the volume of mercury penetrated into the pores is measured. The pressure and the volume of mercury penetrated into the pores have a relation represented by the following expression: PD=−4σ COS θ, provided that the pressure, the pore diameter, the contact angle and the surface tension of mercury are defined as P, D, θ and σ, respectively. If the contact angle and the surface tension are defined as constant numbers, the pressure P and the diameter D of the pores into which mercury can penetrate at the pressure P are inversely proportional. Accordingly, the volume V of mercury penetrated at the pressure P is calculated as an integrated value of the pore volume for each pore diameter by substituting the abscissa P of a P-V curve obtained by changing the pressure with the pore diameter from the expression. The integrated value of the pore volume for each pore diameter is differentiated and used as the volume value of the pore in each pore diameter, which is defined as the differential pore volume. In the mercury intrusion method, the void between the porous magnetic core particles can be determined together with the pores present in the porous magnetic core particles.

However, in order to alleviate coarseness and carrier adhesion, it is important to control the void but not the pore. For this reason, in order to reduce coarseness and alleviate carrier adhesion, it is important to adjust the pore diameter in which the differential pore volume of the pore diameter of 0.10 μm or more and 3.00 μm or less is maximum, to 0.80 μm or more and 1.50 μm or less, and P1 to 0.05 ml/g or more and 0.50 ml/g or less.

The mechanism is unclear, but is presumed as follows.

In a high-temperature and high-humidity condition (a temperature of 30° C. and a humidity of 80% RH), frictional charging performance of the magnetic carrier decreases and the frictional charge quantity of the toner decreases in some cases. In this case, since the coulomb force between the toner and an electrostatic image on an electrostatic image bearing member decreases, it is difficult for the toner to be use for development and coarseness is liable to occur.

However, if P1 is adjusted to 0.05 ml/g or more and 0.50 ml/g or less, the frictional charging performance of the magnetic carrier may be increased and coarseness may be alleviated even in a high-temperature and high-humidity condition (a temperature of 30° C. and a humidity of 80% RH). The reason is unclear, but is presumed as follows.

The magnetic carrier of the present invention is obtained by incorporating a resin into the porous magnetic core particles. When incorporating the resin, if the maximum value of the differential pore volume of the porous magnetic core particles in the pore diameter range of 0.80 μm or more and 1.50 μm or less is 0.05 ml/g or more, a certain amount or more of pores is present in the porous magnetic core particles. If the resin is filled in the pores, the resin and the porous magnetic core particles are strongly bonded on the wide surface area. Therefore, when numerous sheets are printed, even if a strong stress is applied to the magnetic carrier, the resin is rarely detached from the porous magnetic core particles. Thus, the magnetic carrier of the present invention can reduce the frictional charging inhibition caused by the detached resin, can have high frictional charging performance as a magnetic carrier, and can increase the frictional charge quantity of the toner.

In addition, although the porous magnetic core particles of the present invention have a small amount of magnetic materials in the magnetic carrier, they can maintain strength because of the suitable pore diameter distribution. For example, where the consumption of the toner is less, the embedment of an external additive into the toner particles is promoted and the adhesion force between the magnetic carrier and the toner increases. Consequently, a large stress is applied to the magnetic carrier during stirring of the toner particles. For example, a case may be cited in which 50,000 sheets were printed at a low image ratio (an image ratio of 1%). Even in such a case, the carrier of the present invention can suppress the breakage of the magnetic carrier and can alleviate the adhesion of the magnetic carrier onto the toner image.

If P1 of the porous magnetic core particles is smaller than 0.05 ml/g, when the resin is incorporated into the porous magnetic core particles, the resin is difficult to fill in the pores and the adhesion area between the resin and the porous magnetic core particles becomes small, whereby the adhesion force becomes weak. Thus, if a strong stress is applied to the magnetic carrier, the amount of the resin detached from the porous magnetic core particles increases. The detached resin inhibits the toner from being frictionally charged and coarseness occurs in some cases.

If P1 is larger than 0.5 ml/g, the decrease of the strength of the magnetic carrier can not be suppressed, and when 50,000 sheets are printed out at a low image ratio, the magnetic carrier is broken and adhered onto images in some cases.

At the same time, in order to increase the strength of the magnetic carrier while improving coarseness in a high-temperature and high-humidity condition (a temperature of 30° C. and a humidity of 80% RH), it is required that the pore diameter in which the differential pore volume in the pore diameter range of 0.10 μm or more and 3.00 μm or less is maximum, is adjusted to 0.80 μm or more and 1.50 μm or less.

When the pore diameter in which the differential pore volume is maximum, is adjusted to 1.5 μm or less, the pores of the porous magnetic core particles are densely present. The porous magnetic core particles are constituted in a structure in which porous magnetic materials are three-dimensionally densely combined and the decrease of the strength of the porous magnetic core particles is less in comparison with cores having no pores. Accordingly, when 50,000 sheets are printed out at a low image ratio (an image ratio of 1%), the breakage of the magnetic carrier can be suppressed and the adhesion of the magnetic carrier on an image can be alleviated.

When the pore diameter in which the differential pore volume is maximum, is adjusted to 0.8 μm or more, a resin may be easily incorporated into the pores of the porous magnetic core particles, and the resin and the porous magnetic core particles are strongly bonded on a wide surface area. Thus, even if a strong stress is applied to the carrier when numerous sheets are printed, the detachment of the resin from the porous magnetic core particles can be reduced. Consequently, the carrier can reduce the frictional charging inhibition caused by the detached resin, can have high frictional charging performance as a magnetic carrier, can increase the frictional charge quantity of the toner even in a high-temperature and high-humidity condition, and can alleviate coarseness.

If the pore diameter in which the differential pore volume is maximum, is larger than 1.5 μm, the three-dimensional structure of the porous magnetic materials becomes sparse and the strength of the porous magnetic core particles may not be maintained. Accordingly, the strength decrease of the magnetic carrier may not be suppressed, and when 50,000 sheets are printed out at a low image ratio, the carrier is broken and adhered onto an image in some cases.

If the pore diameter in which the differential pore volume is maximum is smaller than 0.8 μm, the influence of the surface tension is large because the pores are too fine and the pores are difficult to wet with a resin solution. Consequently, the resin is not incorporated into the pores and the adhesion area between the porous magnetic core particles and the resin becomes small in some cases.

Therefore, as a result of earnest studies made by the present inventors, it has been found that when numerous sheets are printed, if a strong stress is applied to the magnetic carrier, the resin detached from the porous magnetic core particles inhibits the toner from being frictionally charged and coarseness occurs in some cases.

Further, as a result of earnest studies made by the present inventors, it has been found that when the ratio (P2/P1) between the pore diameter and the pore diameter distribution of the porous magnetic core particles is adjusted to 0.05 or more and 0.30 or less, even if 50,000 sheets are printed out at a low image ratio (image ratio of 1%), it is possible to alleviate fogging when printing out is carried out after an image forming apparatus body is allowed to stand for one week in a high temperature and high humidity environment, while reducing the carrier adhesion onto the toner image.

P1 is a maximum value of the differential pore volume in the pore diameter of 0.80 μm or more and 1.50 μm or less, where the porous magnetic core particles and a resin may be bonded on a wide area as described above, the detached resin can be reduced, the charge imparting performance of the carrier can be increased and coarseness can be alleviated even in a high temperature and high humidity environment (a temperature of 30° C. and a humidity of 80% RH).

P2 is a maximum value of the differential pore volume in the pore diameter of 2.0 μm or more and 13.0 μm or less, which is required to fill a resin uniformly in a pore of 2.0 μm, especially a pore of 0.80 μm or more and 1.50 μm or less in which the differential pore volume is maximum.

The mechanism is unclear, but is presumed as follows.

When a resin is uniformly filled in the vicinity of the surfaces of the porous magnetic core particles, the frictional charging performance is the same at all the places of the surfaces of the magnetic carrier particles. However, if the resin is not filled, the frictional charging performance varies depending on the places of the surfaces of the magnetic carrier particles. This is presumed to be that the specific permittivity of a resin (for example, a silicone resin: approximately 4.0, an acrylic resin: approximately 3.5) and the specific permittivity of air (approximately 1.0) are different from each other.

As described above, when the vicinity of the surfaces of the magnetic carrier particles in the present invention is microscopically viewed, a place incorporated with a resin has a repeated structure of “magnetic material-resin-magnetic material”, and a place unincorporated with a resin has a repeated structure of “magnetic material-air-magnetic material”.

When the repeated structure is considered as a condenser, since the specific permittivity of the resin and that of air are different from each other, the electrostatic capacitance is different between the place incorporated with the resin and the place unincorporated with the resin. Therefore, if the resin is not filled uniformly on the porous magnetic core particle surface, the non-uniformity in the electrostatic capacitance occurs depending on the place of the magnetic carrier and the friction charging performance varies depending on the places of the surfaces of the magnetic carrier particles, and thus the distribution of the frictional charge quantity of the toner occurs. In addition, the present inventors consider that when being allowed to stand in a high temperature and high humidity condition, the toner whose frictional charge quantity is reduced is attached in a non-image region, which is observed as fogging.

Therefore, it is important to uniformly fill a resin in the pores in the vicinity of the surfaces of the magnetic carrier particles. When the resin is filled in the porous magnetic core particles, a resin solution and the porous magnetic core become miscible in large pores and then the pores comes to be filled with the resin solution. In order to inhibit fogging by uniformly filling the resin in the porous magnetic core particles of the magnetic carrier, it is important to fill uniformly the resin even into the smaller pores of the porous magnetic core particles.

As described above, the porous magnetic core particles used in the present invention often have a pore diameter of 0.8 μm or more and 1.50 μm or less. Hence, it is important to fill the resin uniformly in pores of 0.8 μm or more and 1.50 μm or less. However, in the pores of 0.8 μm or more and 1.50 μm or less, the pores are difficult to wet because the influence of the surface tension is large and the resin is not filled in the pores in some cases. Consequently, a certain amount or more of pores of 2.0 μm or more having less influence of the surface tension is required to be present. However, in pores of 3.0 μm as measured by a mercury intrusion method, since a void between the porous magnetic core particles is measured, pores of 2.0 μm or more and 3.0 μm or less are required, and hence, the maximum value of the differential pore volume is defined as P2.

If the ratio P2/P1 of 0.05 or more and 0.30 or less is present, firstly, the porous magnetic core is wetted with the resin solution in the pore portion of 2.0 μm or more and 3.0 μm or less and filled. The resin is uniformly filled in small pores of 2.0 μm or less, the magnetic carrier particles has uniform charging performance at all the places of their surfaces and may alleviate fogging when printing is carried out after an image forming apparatus body is allowed to stand for one week in a high temperature and high humidity environment.

If the ratio P2/P1 is smaller than 0.05, since pores of 2.0 μm or more are less which have less influence of the surface tension and in which the porous magnetic core is easily wetted with the resin solution, the resin is not filled in pores of 2.0 μm or less in some cases, and fogging may occur when printing is carried out after an image forming apparatus body is allowed to stand for one week in a high temperature and high humidity environment.

If the ratio P2/P1 is larger than 0.30, since many large pores of 2.0 μm or more and 3.0 μm or less are present, the three-dimensional structure of the porous magnetic materials becomes sparse and the strength of the porous magnetic core particles may not be maintained. As a result, even when 50,000 sheets are printed at a low image ratio (image ratio of 1%), the magnetic carrier is broken and adhered onto a toner image in some cases.

As described above, when the pore diameter in which the differential pore diameter of the porous magnetic core particles is maximum, is adjusted to 0.80 μm or more and 1.50 μm or less, P1 is adjusted to from 0.05 ml/g or more to 0.50 ml/g or less and the ratio P2/P1 is adjusted to from 0.05 or more to 0.30 or less, firstly, it is possible to alleviate all of the coarseness in a high temperature and high humidity environment, the fogging when 50,000 sheets are printed after an image forming apparatus body is allowed to stand for one week in a high temperature and high humidity environment and the magnetic carrier adhesion when 50,000 sheets are printed at a low image ratio (an image ratio of 1%).

The pore diameter in which the differential pore diameter becomes maximum, P1 and the ratio P2/P1 may be controlled by changing the particle diameter and particle diameter distribution of the slurry at the time of preparing the porous magnetic core particles and the calcination temperature and time in a regular calcination step. This will be described in detail in the section of the production method of the magnetic carrier.

In addition, the breakdown electric field intensity of the porous magnetic core particles is preferably 400 V/cm or more and 2000 V/cm or less, because coarseness can be alleviated and blank areas in a low humidity environment can be alleviated. The reason therefore is unclear, but is presumed as follows.

As described above, in the magnetic carrier, charges (counter-charges) having a polarity opposite to toner charges accumulate in the carrier at the time of development with the toner. Thus, the charging performance of the magnetic carrier in which the counter-charges accumulate deteriorates and the frictional charge quantity of the toner decreases, and as a result, coarseness in a high humidity environment occurs in some cases.

In addition, if the counter-charges become large, since the coulomb force between the toner and the magnetic carrier becomes large, the toner becomes difficult to separate from the magnetic carrier and the development efficiency is decreased in some cases. When an image in which a half-tone and a solid portion are adjacent to each other is printed out, the half-tone portion is difficult to develop with the toner due to an edge effect. Therefore, in some cases, a phenomenon (blank areas) occurs in which the concentration of the half-tone image is decreased.

However, if the counter-charges accumulate and the electric field intensity during development is increased, the magnetic carrier of the present invention causes a breakdown, the resistance of the porous magnetic core is rapidly decreased, a path through which the counter-charges flow is formed in the magnetic carrier, thereby causing the counter-charges to effectively escape to a developer carrying member. For this reason, the coarseness can be alleviated in a humidity environment. At the same time, since the adhesion force between the toner and the carrier may be decreased even in a low humidity environment, the developability is enhanced and blank areas can be alleviated.

Further, the magnetic carrier of the present invention can reduce a peak-to-peak voltage (Vpp) in an alternating electric field, whereby the occurrence of a phenomenon (ring mark) can be suppressed in which a ring-shaped or spot-shaped state occurs on recording paper.

The alternating electric field means an electric field generated by applying to the developer carrying member an alternating voltage together with a direct voltage. The purpose of applying the alternating electric field is to rearrange the toner on an electrostatic latent image bearing member and improve dot reproducibility so as to cause more toner to participate in development, that is, to obtain high developability.

In the alternating electric field, in order to obtain high image quality, it is preferable that the peak-to-peak voltage (Vpp) is 0.5 kV or more and 2.0 kV or less, and the frequency is approximately 1.0 kHz or more and 3.0 kHz or less. The Vpp is preferably decreased as low as possible. However, if the Vpp is decreased, the developability is significantly decreased. When the Vpp is increased, sufficient developability is obtained, while too high electric field intensity causes a discharge phenomenon and a ring mark is generated on recording paper in some cases.

Since the magnetic carrier of the present invention can effectively allow the counter-charges escape to the developer carrying member, the Vpp is preferably 1.5 kV or less. More preferably, the Vpp is 1.3 kV, where a ring mark may be reduced, a high quality image can be obtained, and at the same time, high developability can be obtained.

In addition, in the porous magnetic core particles, the pore diameter in which the differential pore volume is maximum, is from 0.80 μm or more and the ratio P2/P1 is 0.05 or more. As described above, if the pore diameter in which the differential pore volume is maximum is adjusted to 0.8 μm or more and the ratio P1/P2 is adjusted to 0.05 or more, the resin is easily incorporated into the pores of the porous magnetic core particles. For this reason, the magnetic carrier of the present invention contains much resin in the vicinity of the surfaces of the porous magnetic core particles. Since much resin is present in the vicinity of the surfaces of the porous magnetic core particles, although the breakdown voltage of the porous magnetic core particles is low, the magnetic carrier may suppress excessive leakage. Even when using porous magnetic core particles having a low breakdown voltage of 2000 V/cm or less, the image quality deterioration can be suppressed which is caused by the occurrence of excessive leakage at the magnetic carrier and the disruption of the electrostatic image on the electrostatic image bearing member. On the other hand, in the case of a magnetic carrier using porous magnetic core particles where the pore diameter in which the differential pore volume is maximum is less than 0.80 μm, the ratio P1/P2 is less than 0.05 and the breakdown voltage is 2000 V/cm or less, excessive leakage occurs during development, the electrostatic image on the electrostatic image bearing member is disrupted and the image quality deteriorates in some cases. In addition, even if the pore diameter in which the differential pore volume is maximum is adjusted to less than 0.80 μm, the ratio P1/P2 is adjusted to 0.05 or more, when a magnetic carrier having a breakdown voltage of 400 V/cm or less is used, excessive leakage occurs during developing, the electrostatic image on the electrostatic image bearing member is disrupted and the image quality deteriorates in some cases.

The porous magnetic core particles may be produced through the following steps.

The material of the porous magnetic core particles is preferably a ferrite.

The ferrite particle is a sintered product represented by the following formula.

The ferrite is a sintered product represented by the following formula.

(M1₂O)ₓ(M2O)_{y}(Fe₂O₃)_{z} (wherein, M1 is a monovalent metal, M2 is a divalent metal, where x+y+z=1.0, x and y satisfy the following condition: 0≦(x, y)≦0.8 and z satisfies the following condition: 0.2<z<1.0.)

In the above formula, as M1 and M2, it is preferable to use one or more metal atoms selected from the group consisting of Li, Fe, Mn, Mg, Sr, Cu, Zn, Ni, Co and Ca.

A magnetic Li-type ferrite (for example, (Li₂O)ₐ(Fe₂O₃)_{b} (0.0<a<0.4, 0.6≦b<1.0, a+b=1, (Li₂O)ₐ(SrO)_{b}(Fe₂O₃)_{c} (0.0<a<0.4, 0.0<b<0.2, 0.4≦c<1.0, a+b+c=1)); a Mn-type ferrite (for example, (MnO)ₐ(Fe₂O₃)_{b} (0.0<a<0.5, 0.5≦b<1.0, a+b=1)); a Mn—Mg-type ferrite(for example, (MnO)ₐ(MgO)_{b}(Fe₂O₃)_{c} (0.0<a<0.5, 0.0<b<0.5, 0.5≦c<1.0, a+b+c=1)), a Mn—Mg—Sr-type ferrite (for example, (MnO)ₐ(MgO)_{b}(SrO)_{c}(Fe₂O₃)_{d} (0.0<a<0.5, 0.0<b<0.5, 0.0<c<0.5, 0.5≦d<1.0, a+b+c+d=1); and a Cu—Zn-type ferrite (for example, (CuO)ₐ(ZnO)_{b}(Fe₂O₃)_{c} (0.0<a<0.5, 0.0<b<0.5, 0.5≦c<1.0, a+b+c=1). The above ferrites may contain a small amount of other metals.

From the viewpoint of being capable of easily controlling the growth speed of a crystal and being capable of suitably controlling the pore diameter distribution of the porous magnetic cores, a Mn-type ferrite, a Mn—Mg-type ferrite and a Mn—Mg—Sr-type ferrite are preferable.

A production method of the porous magnetic core particles will be described below in detail in which ferrite particles are used as porous magnetic carrier particles.

Step 1 (Weighing and Mixing Step)

The raw materials of the above ferrites are weighed and mixed.

In order to control the pore diameter distribution of the porous magnetic core particles and the electric field intensity immediately before breakdown to a desired value, the ferrite raw material includes the following: particles of a metal selected from Li, Fe, Zn, Ni, Mn, Mg, Co, Cu, Sr and Ca; an oxide of a metal element; an oxalate of a metal element; and a carbonate of a metal element.

A mixing apparatus includes a ball mill, a planetary mill and a Giotto mill. Especially, a wet-type ball mill using a slurry having a solid matter concentration of 60% by mass or more and 80% by mass or less in water is preferable because of the mixing property and the formation of a porous structure. Specifically, the weighed raw materials and balls are placed in a ball mill, followed by pulverization and mixing for 0.1 hours or more and 20 hours or less.

Step 2 (Preliminary Calcination Step)

The pulverized and mixed ferrite raw materials are granulated and dried by using a spray dryer and then subjected to preliminary calcination by setting the calcination temperature at 700° C. or more and 1000° C. or less in the air for 0.5 hours or more and 5.0 or less to thereby obtain a ferrite. If the temperature exceeds 1000° C., sintering proceeds and the ferrite is difficult to pulverize up to a particle diameter for making it porous in some cases.

The calcinating apparatus includes a burner-type incinerator, a rotary type incinerator and an electric furnace.

Step 3 (Pulverization Step)

The preliminarily calcined ferrite prepared in Step 2 is pulverized by a pulverizer.

The pulverizer includes a crasher, a hammer mill, a ball mill, a beads mill, a planetary mill and a Giotto mill.

The pulverized product of the preliminarily calcined ferrite has preferably a 50% particle diameter (D50) based on volume of 0.5 μm or more and 5.0 μm or less. Thus, it is possible to easily control the pore diameter in which the differential pore volume is maximum and P1 (the maximum value of the differential pore volume in the range of 0.8 μm or more to 1.5 μm or less).

In addition, the 90% particle diameter (D90) based on volume is preferably set to be 3.0 μm or more and 10.0 μm or less. Thus, the ratio P2/P1 can be controlled.

In order to adjust the particle diameter of the pulverized product of the ferrite to the above particle diameter, for example, it is preferable to control the material, particle diameter and operation time of balls or beads used in a ball mill or a beads mill. Specifically, in order to reduce the particle diameter of the preliminarily calcined ferrite slurry, balls or beads having a high specific gravity may be used or the pulverization time may be extended. In addition, in order to extend the particle size distribution of the preliminarily calcined ferrite, it can be achieved by shortening the pulverization time using balls or beads having a high specific gravity. Further, a preliminarily calcined ferrite having a wide particle size distribution can be obtained by mixing plural preliminarily calcined ferrites for which the pulverization conditions of a ball mill or a beads mill are different.

The material of the balls or beads is not particularly limited as long as a desired particle diameter and distribution can be obtained. For example, the following may be cited: glass such as soda glass (specific gravity: 2.5 g/cm³), glass without soda (specific gravity: 2.6 g/cm³) and high specific gravity glass (specific gravity: 2.7 g/cm³), quartz (specific gravity: 2.2 g/cm³), titania (specific gravity: 3.9 g/cm³), silicon nitride (specific gravity: 3.2 g/cm³), alumina (specific gravity: 3.6 g/cm³), zirconia (specific gravity: 6.0 g/cm³), steel (specific gravity: 7.9 g/cm³) and stainless steel (specific gravity: 8.0 g/cm³). Among these, alumina, zirconia and stainless steel are preferable because they are excellent in abrasion resistance.

The particle diameter of the balls or beads is not particularly limited as long as a desired particle diameter and distribution can be obtained. For example, as a ball, preferably used is a ball having a diameter of 5 mm or more and 60 mm or less. In addition, beads are preferably used having a diameter of 0.03 mm or more and 5 mm or less.

Further, as the ball mill or beads mill, a wet-type mill using water such as a slurry using is more preferable than a dry-type mill because the pulverization efficiency is high and the particle size distribution of the pulverized product of the preliminarily calcined ferrite is easily controlled.

Step 4 (Granulation Step)

To the pulverized product of the preliminarily calcined ferrite, water, binder and, as needed, a pore-adjusting agent are added.

In Step 3, if the ferrite is pulverized by a wet-type mill, taking into account water contained in the ferrite slurry, it is preferable to add a binder and, as needed, a pore-adjusting agent. In order to control the degree of porousness, granulation is preferably carried out by adjusting the solid matter concentration of the slurry to 50% by mass or more and 80% by mass or less.

The resulting ferrite slurry is dried and granulated under a heated atmosphere at 100° C. or more and 200° C. or less using a spray drying machine.

As the spray drying machine, a spray dryer is preferably used because the porous magnetic core particle diameter may be adjusted to a desired range. The porous magnetic core particle diameter may be controlled by arbitrarily selecting the rotation number and spraying amount of a disk used in the spray dryer.

Step 5 (Regular Calcination Step)

Subsequently, the granulated product is calcined at a temperature of 800° C. or more and 400° C. or less for one hour or more and 24 hours or less. The temperature is more preferably 1000° C. or more and 1200° C. or less. In order to adjust P1 to 0.05 ml/g or more and 0.50 ml/g or less, the calcination temperature and calcination time are preferably controlled in the above range.

If the calcination temperature is increased and the calcination time is extended, the sintering of the porous magnetic core particles proceeds, and thus the pore diameter is decreased and the number of pores is reduced. In addition, if the atmosphere of calcination is controlled, it is possible to control the electric field intensity immediately before the breakdown of the porous magnetic core particles in a desired range. If the oxygen concentration is adjusted to preferably 0.1% by volume and more preferably 0.01% by volume, the specific resistance of the porous magnetic core particles may be adjusted in a desired range. Further, if the calcination is carried out under a reduction atmosphere (in the presence of hydrogen), it is possible to reduce the breakdown electric filed intensity of the porous magnetic core particles.

Step 6 (Sorting Step)

The particles calcined as above are pulverized and then, where necessary, coarse particles or fine particles may be removed by classification or screening with a sieve.

If the porous magnetic core particle have a 50% particle diameter (D50) based on volume of 18.0 μm or more and 68.0 μm or less, it is preferable to suppress the carrier adhesion onto an image and coarseness.

The porous magnetic core particles thus obtained are lowered in physical strength depending on the number or size of pores and become brittle in some cases. For this reason, the physical strength as a magnetic carrier may be increased by filling a resin in the porous magnetic core particles and then coating with the resin after filling the resin.

The method of incorporating the resin into the porous magnetic core particles includes the following two methods: a method of filling the resin in the back pores of the porous magnetic core particles and a method of filling the resin only in the pores at the surface of the porous magnetic core particles. The specific filling method is not particularly limited, but is preferably a method of filling a resin solution obtained by mixing a resin and a solvent in the pores of the porous magnetic core particles.

The amount of solid content in the resin solution is preferably 1% by mass or more and 50% by mass or less and more preferably 1% by mass or more and 30% by mass or less. If a resin solution in which the resin is contained in an amount more than 50% by mass is used, it is difficult to uniformly fill the resin solution in the pores of the porous magnetic core particles because of the high viscosity of the resin solution. In addition, if the resin amount is less than 1% by mass, the adhesion force of the resin to the porous magnetic core particles is decreased in some cases.

The resin filled in the pores of the porous core particles is preferably one uniformly filled in pores smaller than 2.0 μm, but is not particularly limited thereto. The solvent to be used is preferably toluene, and a resin solution in which the viscosity of a 20% by mass resin solution in toluene is 1.0×10⁻⁶ m²/s or more and 1.0×10⁻³ m²/s because it facilitates filling.

The resin filled in the pores of the porous magnetic core particles is not particularly limited and either a thermoplastic resin or a thermosetting resin may be used, but preferred is one having an affinity with porous magnetic core particles. If a resin having a high affinity with porous magnetic core particles is used, when the resin is filled in the pores of porous magnetic core particles, it is easy to cover the surfaces of the porous magnetic core particles with the resin.

Specifically, a silicone resin or a modified silicone resin is preferable because of a high affinity with porous magnetic core particles.

The commercially available product includes the following: as a straight silicone resin, KR 271, KR 255 and KR 152 produced by Shin-Etsu Chemical Co., Ltd.; and SR 2400, SR 2405, SR 2410 and 2411 produced by Dow Corning Toray Co., Ltd., and as a modified silicone resin, KR 206 (alkyd-modified), KR 5208 (acryl-modified), ES 1001N (epoxy-modified) and KR 305 (urethane-modified) produced by Shin-Etsu Chemical Co., Ltd.; and SR 2115 (epoxy-modified) and SR 2110 (alkyd-modified) produced by Dow Corning Toray Co., Ltd.

As a method of filling a resin in pores in porous magnetic core particles, a method may be employed in which a resin is diluted in a solvent and the resulting solution is added to pores in porous magnetic core particles. The solvent used in this case may be one capable of dissolving a resin. In the case of a resin soluble in an organic solvent, the organic solvent includes toluene, xylene, cellosolve butyl acetate, methyl ethyl ketone, methyl isobutyl ketone and methanol. In addition, in the case of a water-soluble resin or an emulsion-type resin, water may be used as a solvent. The method of filling a resin in pores of porous magnetic core particles includes an immersion method, a spraying method, a brushing method, and a method in which porous magnetic core particles are immersed in a resin solution by a coating method like a fluidized bed and then the solvent is evaporated.

In the magnetic carrier of the present invention, in order to improve fogging when printing is carried out after an image forming apparatus body is allowed to stand for one week in an environment of a temperature of 30° C. and a humidity of 80% RH by further controlling the surface exposure degree of porous magnetic core particles, if a resin is filled in pores of porous magnetic core particles and then their surfaces are coated with the resin, it is preferable for the purpose of improving the durability of the magnetic carrier.

As the coating resin, a silicone resin or a modified silicone resin is preferably used because it has a high affinity with particles in which a resin is filled in pores of porous magnetic core particles. The commercially available product includes the following: as a straight silicone resin, KR 271, KR 255 and KR 152 produced by Shin-Etsu Chemical Co., Ltd.; and SR 2400, SR 2405, SR 2410 and 2411 produced by Dow Corning Toray Co., Ltd., and as a modified silicone resin, KR 206 (alkyd-modified), KR 5208 (acryl-modified), ES 1001N (epoxy-modified) and KR 305 (urethane-modified) produced by Shin-Etsu Chemical Co., Ltd.; and SR 2115 (epoxy-modified) and SR 2110 (alkyd-modified) produced by Dow Corning Toray Co., Ltd.

The above resins may be used alone or may be used by mixing two or more of them. In addition, a thermoplastic resin may be used after curing by mixing a curing agent. Especially, it is preferable to use a resin having a high releasing property.

In addition, the coating material may contain particles having electrical conductivity or a charge controlling material in order to control the charge imparting property of the carrier.

The particles having electrical conductivity include particles of carbon black, magnetite, graphite, zinc oxide and tin oxide.

As the charge controlling material, particles having a charge controlling property or a material having a charge controlling property may be used.

The particles having a charge controlling property include the following.

For example, particles of an organic metal complex, particles of an organic metal salt, particles of a chelate compound, particles of a monoazometal complex, particles of an acetyl acetone metal complex, particles of a hydroxycarboxylic acid metal complex, particles of a polycarboxylic acid metal complex, particles of a polyol metal complex, particles of a polymethylmethacrylate resin, particles of a polystyrene resin, particles of melamine resin, particles of a phenol resin, particles of a nylon resin, particles of silica, particles of titanium oxide and particles of aluminum.

As a method of coating the surfaces of the porous magnetic core particles after filling with a resin, an immersion method, a spraying method, a brushing method and a method of coating by a coating method like a fluidized bed. Next, the toner used in the present invention will be described.

The toner in the present invention may be any one. However, if the toner having a circle-equivalent diameter of 1.985 μm or more and less than 39.69 μm has an average circularity of 0.940 or more and 1.000 or less, it is preferable because the adhesion force between the magnetic carrier and the toner may be adequately controlled, and thus, coarseness may be alleviated, where the average circularity is obtained by dividing circularities measured by a flow-type particle image analyzer having an image processing resolution of 512×512 pixels (0.37 μm×0.37 μm per pixel) into 800 in a circularity range of 0.200 or more to 1.000 or less, and analyzing the circularities.

The circularity of the toner may be controlled by the production method of the toner described later or by the surface modifying treatment of the toner particles.

In order to obtain a toner achieving the compatibility between storage stability and low temperature fixability, the binding resin of the toner preferably has a peak molecular weight (Mp) of 2000 or more and 50,000 or less in the molecular weight distribution measured by gel permeation chromatography (GPC), a number average molecular weight (Mn) of 1500 or more and 30,000 or less, a weight average molecular weight (Mw) of from 2000 or more to 1,000,000 or less and a glass transition point (Tg) of from 40° C. or more to 80° C. or less.

Wax is preferably used in an amount of from 0.5 parts by mass to 20 parts by mass based on 100 parts by mass of the binding resin. In addition, if the wax has a maximum endothermic peak temperature of from 45 to 140° C., it is preferable because the toner can achieve the compatibility between storage stability and low temperature fixability.

The wax includes a hydrocarbon-type wax such as a low molecular weight polyethylene, a low molecular weight polypropylene, an alkylene copolymer, microcrystalline wax, paraffin wax and Fischer-Tropsch wax; an oxide of a hydrocarbon-type wax such as a polyethylene oxide wax or a block copolymer thereof; waxes mainly including a fatty acid ester such as carnauba wax, behenyl behenate wax and montanic acid ester wax; and partially or wholly deacidified fatty acid esters such as deacidified carnauba wax.

The amount of a colorant to be used is preferably 0.1 parts by mass or more and 30 parts by mass or less, and more preferably 0.5 parts by mass or more and 20 parts by mass or less, based on 100 parts by mass of the binding resin.

A charge controlling agent may be incorporated into the toner, where necessary. As the charge controlling agent incorporated into the toner, a well-known charge controlling agent may be used. However, a metal compound of an aromatic carboxylic acid is especially preferred which is colorless, can significantly raise the charging speed of the toner and can stably maintain a fixed charge amount.

The charge controlling agent for a negatively chargeable toner includes a salicylic acid metal compound, a naphthoic acid metal compound, a polymer type compound having a sulfonic acid or a carboxylic acid in the side chain, a polymer type compound having a sulfonic acid salt or sulfonic acid esterified product in its side chain, a boron compound, an urea compound, a silicon compound and calixarene. The charge controlling agent for a positively charged toner includes a quaternary ammonium salt, a polymer type compound having the quaternary ammonium salt in its side chain, a guanidine compound and an imidazole compound. The charge controlling agent may be added internally or externally. The amount of the charge controlling agent to be added is preferably 0.2 parts by mass or more and 10 parts by mass or less based on 100 parts by mass of the binding resin.

In order to increase the fluidity of the toner, an external additive is preferably added to the toner. As the external additive, an inorganic fine powder such as silica, titanium oxide and aluminum oxide is preferable. The inorganic fine powder is preferably made hydrophobic with a hydrophobicity-imparting agent such as a silane compound, silicone oil or a mixture thereof.

The external additive is preferably used in an amount of 0.1 parts by mass or more and 5.0 parts by mass or less based on 100 parts by mass of the toner particles.

The toner particles and the external additive may be mixed using a well-known mixer such as a Henschel mixer.

The method for producing the toner particles includes, for example, a pulverization method in which a binding resin and a colorant are melt-kneaded and the kneaded product is cooled, followed by pulverization and classification; a suspension granulation method in which a solution obtained by dissolving or dispersing a binding resin and a colorant in a solvent is introduced in an aqueous medium and is suspended and granulated, followed by removing the solvent to obtain toner particles; a suspension polymerization method in which a monomer composition obtained by uniformly dissolving or dispersing a colorant and the like in a monomer is dispersed in a continuous phase (for example, water phase) containing a dispersion stabilizer, followed by polymerization to prepare toner particles; a dispersion polymerization method of directly forming toner particles using an aqueous organic solvent in which a monomer is soluble but the resulting polymer is insoluble; an emulsification polymerization method of forming toner particles by direct polymerization in the presence of an aqueous polar polymerization initiator; and an emulsification aggregation method of obtaining toner particles at least through a step of aggregating polymer fine particles and colorant fine particles to form fine-particle aggregates and a step of causing fusion between fine particles in the fine-particle aggregates.

Toner production procedures in the pulverization method will be described below.

In the raw material mixing step, as the materials constituting toner particles, for example, the predetermined amounts of a binding resin, a colorant and wax, and where necessary, other components such as a charge controlling agent are weighed, followed by blending. An example of a mixing apparatus includes a double cone mixer, a V-type mixer, a drum-type mixer, a super mixer, a Henschel mixer, a Nauta mixer and Mechano hybrid (manufactured by Mitsui Mining Co., Ltd.).

Subsequently, the mixed materials are melt-kneaded and the colorant is dispersed in the binding resin. In the melt-kneading step, the following may be used: a pressure kneader, a batch-type kneading machine such as a Banbury mixer and a continuous kneading machine. From the viewpoint of the advantage of continuous production, a single or twin screw extruder is mainly used. For example, it includes a twin screw extruder Model KTK (manufactured by Kobe Steel Ltd.), a twin screw extruder Model TEM (manufactured by Toshiba Machine Co., Ltd.), PCM kneader (manufactured by Ikagai Corporation), a twin screw extruder (manufacture by KCK Co., Ltd.), a cokneader (manufactured by Buss AG) and Kneadex (manufactured by Mitsui Mining Co., Ltd.).

In addition, the colored resin composition obtained by melt-kneading is rolled between two rolls and the like, and may be cooled with water in a cooling step.

Thereafter, the quenched product of the resin composition is pulverized into a desired particle diameter in the pulverization step. In the pulverization step, the cooled product is roughly pulverized by a pulverizer such as a crusher, a hammer mill and a feather mill, and further finely pulverized by, for example, a cryptron system (manufactured by Kawasaki Heavy Industries, Ltd.), Super Rotor (manufactured by Nisshin Engineering Inc.), Turbo Mill (manufactured by Turbo Kogyo Co., Ltd.) or a fine pulverizer of an air jet system.

Subsequently, the pulverized product is classified using a classification apparatus or a sieving apparatus such as Elbow-Jet (manufactured by Nittetsu Mining Co., Ltd.), Turboplex of a centrifugal classification system (manufactured by Hosokawa Micron Co., Ltd.), TSP Separator (manufactured by Hosokawa Micron Co., Ltd.), Faculty (manufactured by Hosokawa Micron Co., Ltd.), to thereby obtain toner particles.

In addition, after the pulverization step, the resulting toner particles may be subjected to surface modification treatment such as conglobation treatment using Hybridization System (manufactured by Nara Machinery Co., Ltd.), Mechanofusion System (manufactured by Hosokawa Micron Co., Ltd.), Faculty (manufactured by Hosokawa Micron Co., Ltd.) and Meteorainbow MR Type (manufactured by Nippon Pneumatic Mfg. Co., Ltd.).

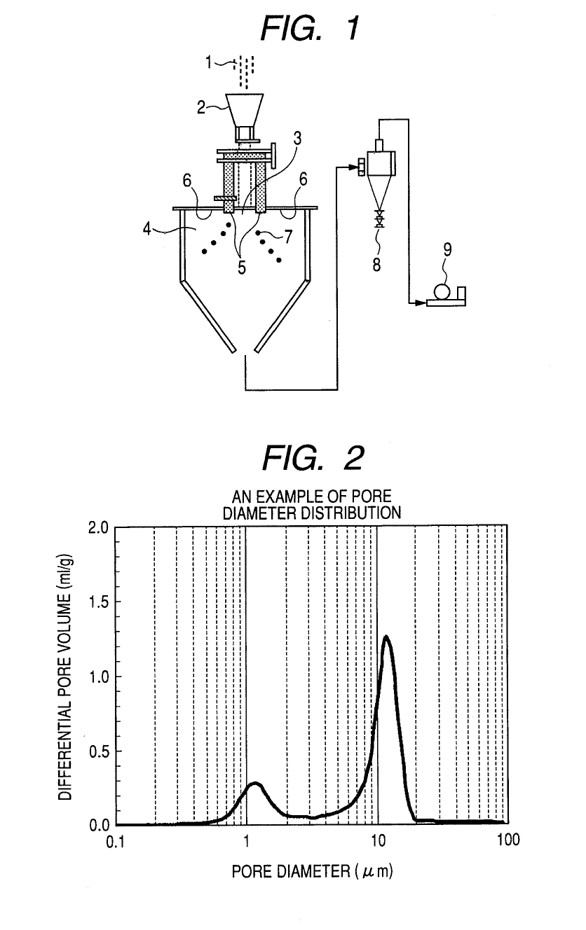

For example, a surface modification apparatus as shown in FIG. 1 may be used for the surface modification of toner particles. Using an auto feeder 2, toner particles 1 are fed through a feed nozzle 3 to the inside of a surface modification apparatus 4. Since the air inside the surface modification apparatus 4 is sucked by a blower 9, toner particles 1 introduced from a feed nozzle 3 are dispersed in the apparatus. The toner particles 1 dispersed in the apparatus are instantaneously heated by hot air introduced from a hot air introduction inlet 5 and then surface-modified. In the present invention, hot air is generated by a heater, however, the apparatus is not particularly limited as long as it generates sufficient hot air for the surface modification of toner particles. Toner particles 7 surface-modified are cooled by cold air introduced from cold air introduction inlet 6. In the present invention, liquid nitrogen is used as cold air, however, the means is not particularly limited as long as it can instantaneously cool the toner particles 7 surface-modified. The toner particles 7 surface-modified are sucked by the blower 9 and collected by a cyclone 8.

The magnetic carrier of the present invention may be used as a two-component developer containing a toner and a magnetic carrier.

The two-component developer may be used as a developer which is carried on a developer bearing member hold in a developing unit and is used.

When the magnetic carrier is used as a developer, the mixing ratio of the toner is preferably 2 parts by mass or more and 35 parts by mass or less and more preferably 4 parts by mass or more and 25 parts by mass or less, based on 100 parts by mass of the magnetic carrier. If the mixing ratio is adjusted within the above range, it is possible to achieve a high image concentration and alleviate scattering of the toner.

The two-component developer containing a magnetic carrier and a toner of the present invention may be used as a developer for replenishment used for a two-component developing method in which the magnetic carrier is replenished in the developing unit and at least the magnetic carrier which is excessive inside the developing unit is discharged from the developing unit.

When the magnetic carrier is used as a two-component developer, from the viewpoint of increasing the durability of the developer, the mixing ratio of the toner is preferably 2 parts by mass or more and 50 parts by mass or less based on 1 parts by mass of the magnetic carrier.

The measurement methods of various physical properties of the magnetic carrier and toner will be described below.

<Pore Particle Diameter Distribution of Porous Magnetic Core Particles>

The pore particle diameter distribution of porous magnetic core particles is measured by a mercury intrusion method.

The measurement principle is as follows.

In this measurement, the pressure applied to mercury is changed and the volume of mercury penetrated into the pores is measured. The conditions in which mercury may penetrate into the pores may be represented by the following expression: PD=−4σ COS θ from the balance of force, provided that the pressure, the pore diameter, the contact angle and the surface tension of mercury are defined as P, D, θ and σ, respectively. If the contact angle and the surface tension are defined as constant numbers, the pressure P and the diameter D of the pores into which mercury may penetrate are inversely proportional. Thus, the pressure P and the volume V of mercury penetrated at the pressure P are determined as pore distribution by replacing the abscissa P of a P-V curve obtained by changing the pressure with the pore diameter from the expression.

The measurement may be carried out using a measurement apparatus such as a fully automatic multifunctional mercury porosimeter Pore Master Series/Pore Master-GT Series manufactured by Yuasa Ionics Inc. and an automatic porosimeter Autopore IV-9500 Series manufactured by Shimadzu Corporation.

Specifically, the measurement was carried out under the following conditions and procedures using Autopore IV 9520 manufactured by Shimadzu Corporation.

Measurement Conditions

| | |
|---|---|
| Measurement environment: | Approximately 20° C. |
| Measurement cell: | Sample volume 5 cm³, |
| | Intrusion volume 1.1 cm³, |
| | Application for Powder |
| Measurement range: | 2.0 psia (13.8 kPa) or more and |
| | 59,989.6 psia (413.7 Mpa) |
| Measurement step: | 80 steps (The steps are divided to be at |
| | equal intervals when the pore diameter is |
| | represented by a logarithm.) |
| Intrusion volume: | Adjusted to be 25% or more and 70% or |
| | less. |
| Low pressure parameter: | Exhaust pressure 50 μmHg |
| | Exhaust time 5.0 min |
| | Mercury intrusion pressure 2.00 |
| | psia (13.8 kPa) |
| | Equilibration time 5 secs |
| High pressure parameter: | Equilibration time 5 secs |
| Mercury parameter: | Forward contact angle 130.0 degrees |
| | Backward contact angle 130.0 degrees |
| | Surface tension 485.0 mN/ |
| | m (485.0 dynes/cm) |
| | Mercury density 13.5335 g/mL |

### Measurement Procedures

(1) Approximately 1.0 g of porous magnetic core particles is weighted in a sample cell.
(2) At a lower pressure portion, the measurement is made in the range of 2.0 psia (13.8 kPa) or more and 45.8 psia (315.6 kPa) or less.
(3) At a higher pressure portion, the measurement is made in the range of 45.9 psia (316.3 kPa) or more and 59,989.6 psia (413.6 kPa).
(4) The pore diameter distribution is calculated from the mercury intrusion pressure and mercury injection volume.

The above procedures (2), (3) and (4) are automatically carried out by the software attached to the apparatus.

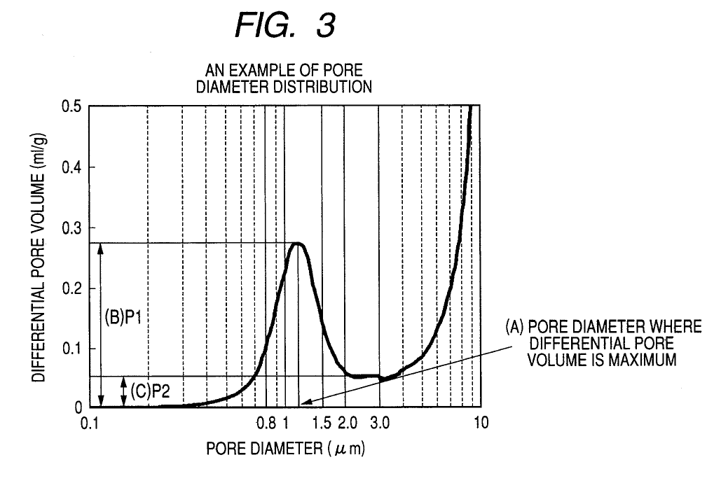

An example of the pore diameter distributions calculated as described above is shown in FIG. 2, and in FIG. 3 which is an enlarged figure of FIG. 2, X-axis represents a pore diameter determined by the mercury intrusion method and Y-axis represents a differential pore volume.

The peak in the pore diameter range of 10 μm or more and 20 μm or less is a void (void between porous magnetic core particles).

The pore diameter of a peak in the pore diameter range of 0.80 μm or more and 1.50 μm or less is defined as a pore diameter (A) in which the differential pore volume is maximum. In addition, the maximum value of the differential pore volume of the peak is defined as P1 (B). Further, the maximum value of the differential pore volume in the range of 2.00 μm or more and 3.00 μm or less is defined as P2.

<Electric Field Intensity of Breakdown of Porous Magnetic Core Particles>

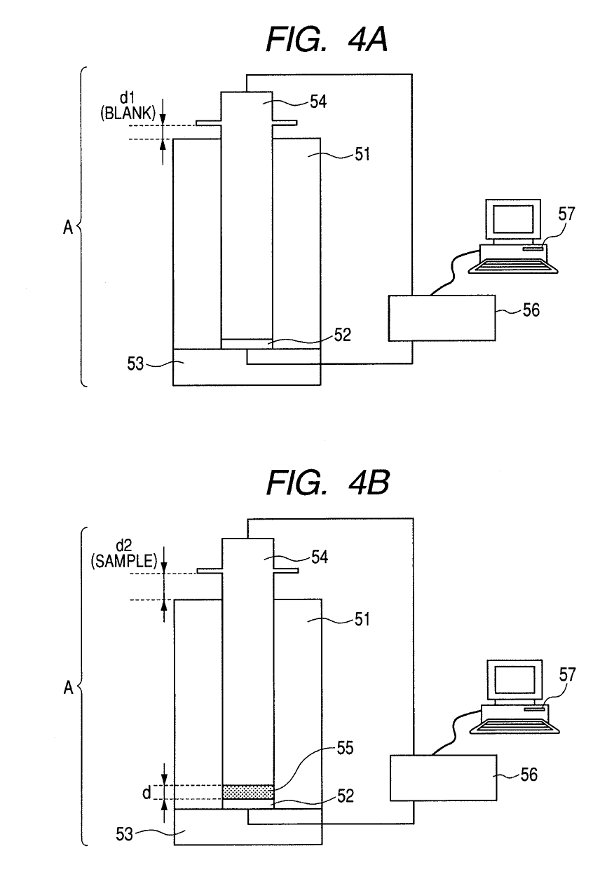

The electric field intensity of breakdown of the porous magnetic core particles is measured by a measuring apparatus outlined in FIGS. 4A and 4B. The measurement is carried out using porous magnetic core particles before incorporating a resin.

The resistance measuring cell A comprises a cylindrical PTFE resin container 51 having a hole with a cross-sectional area of 2.4 cm², a lower electrode 52 (made of stainless steel), a supporting seat 53 (made of PTFE) and an upper electrode 54 (made of stainless steel). The cylindrical PTFE resin container 51 is placed on the supporting seat 53 and is filled with approximately 0.5 to 1.3 g of a sample 55 (porous magnetic core particles), followed by placing the upper electrode 54 on the filled sample to measure the thickness of the sample. If the thickness when a sample is not present is defined as d1 (blank) and the thickness when being filled with approximately 0.5 to 1.3 g of a sample is defined as d2 (sample), the actual thickness d of the sample is represented by the following expression.

d=d2(sample)−d1(blank)

In this case, it is important to appropriately change the amount of the sample so that the thickness of the sample is 0.95 mm or more and 1.04 mm or less.

The electric field intensity of breakdown of the porous magnetic core particles may be determined by measuring a current flowing when a voltage is applied between the electrodes. The measurement is made by using an electrometer 56 (Keithley 6517, manufactured by Keithley Instruments Inc.) and a computer 57 for control.

The measurement is made by software using a control system manufactured by National Instruments LabVIEW and control software (manufactured by National Instruments LabVIEW) as the computer 57 for control. As the measuring conditions, the actually measured value d is entered so that the contact area S between the sample and the electrode is 2.4 cm², the sample thickness is 0.95 mm or more and 1.04 mm or less. In addition, the load of the upper electrode is set to be 120 g and the maximum application voltage is set to be 1000 V.

As the voltage application conditions, screening is carried out by applying to the magnetic carrier a direct voltage of 1 V (2⁰ V), 2 V (2¹ V), 4V (2² V), 8 V (2³ V), 16 V(2⁴ V), 32 V (2⁵ V), 64 V (2⁶ V), 128 V (2⁷ V), 256 V (2⁸ V), 512 V (2⁹ V) and 1000 V for every one second, using the autoranging function of an electrometer with IEEE-488 interface for control between the computer for control and an electrometer. In this case, a judgement on whether a voltage may be applied up to 1000 V (approximately 10,000 V/cm as the electric field intensity) is made by the electrometer, if an overcurrent flows, “VOLTAGE SOURCE OPERATE” blinks. Then, the application voltage is decreased, an applicable voltage is further screened and the maximum value of the application voltage is automatically determined. Thereafter, the measurement is carried out. The resistance value is determined from the current value after being maintained for 30 seconds by using the voltage obtained by dividing the maximum voltage value by five as each step. For example, when the maximum application voltage is 1000 V, the voltage is applied by increasing and then decreasing the voltage in increments or decrements of 200 V in the order of 200 V, 400 V, 600 V, 800 V and 1000 V, and 1000 V, 800 V, 600 V, 400 V and 200 V, and the resistance value is measured from the current value after being maintained for 30 seconds at each step. In addition, for example, in the case of the porous magnetic core 1 used in Example 1, the maximum application voltage is 56.2 V and the direct voltage is applied in the order of 11.2 V, a value of one-fifth of 56.2 V (step 1), 22.5 V, a value of two-fifths of 56.2 V (step 2), 33.7 V, a value of three-fifths of 56.2 V (step 3), 44.9 V, a value of four-fifths of 56.2 V (step 4), 56.2 V, a value of five-fifths of 56.2 V (step 5), 56.2 V, a value of five-fifths of 56.2 V (step 6), 44.9 V, a value of four-fifths of 56.2 V (step 7), 33.7 V, a value of three-fifths of 56.2 V (step 8), 22.5 V, a value of two-fifths of 56.2 V (step 9) and 11.2 V, a value of one-fifth of 56.2 V (step 10). By processing the current values obtained by a computer, the electric field intensity is calculated from the sample thickness and the electrode area and is plotted on a graph. In this case, five points are plotted where the voltage is decreased from the maximum application voltage. In addition, in the measurement at each step, when “VOLTAGE SOURCE OPERATE” blinks and an overcurrent flows, in measurement, the resistance value is displayed as 0. A phenomenon in which “VOLTAGE SOURCE OPERATE” blinks refers to breakdown, and the point at which the maximum electric field intensity of the above profile is plotted as a value of the electric field intensity of breakdown, is defined as the electric field intensity of breakdown. Therefore, if “VOLTAGE SOURCE OPERATE” blinks when the maximum application voltage is applied, the resistance value does not become 0, and if the value can be plotted, the point is defined as the electric field intensity of breakdown. In addition, the electric field intensity is determined by the following expression.

The electric field intensity (V/cm)=The application voltage (V)/d(cm)

<Measurement Method of 50% Particle Diameter (D50) Based on Volume Distribution of Magnetic Carrier Particles and Porous Magnetic Core Particles, and 50% Particle Diameter (D50) Based on Volume Distribution and 90% Particle Diameter (D90) Based on Volume Distribution of Pulverized Product of Preliminarily Calcined Ferrite>

The particle size distribution was measured with a particle size distribution analyzer of a laser diffraction scattering method “Microtrac MT3300EX” (manufactured by Nikkiso Co., Ltd.).

When measuring 50% particle diameter (D50) based on volume distribution and 90% particle diameter (D90) based on volume distribution of the pulverized product of the preliminarily calcined ferrite, a wet-type sample circulator “Sample Delivery Control (SDC)” (manufactured by Nikkiso Co., Ltd.) was fitted. The preliminarily calcined ferrite (“ferrite slurry”) was dropwise added to the sample circulator to be at the measurement concentration. The flow rate was 70%, the ultrasonic wave power was 40 W, and the ultrasonic wave application time was 60 seconds.

The measurement conditions are as follows.
SetZero Time: 10 seconds
Measurement Time: 30 seconds
Measurement Frequency: 10 times
Solvent Refractive Index: 1.33
Particle Refractive Index: 2.42
Particle Shape: Non-sphere
Measurement Upper Limit: 1408 μm
Measurement Lower Limit: 0.243 μm
Measurement Environment: Approximately 23° C./50% RH

When measuring the 50% particle diameters (D50) base on volume distribution of the magnetic carrier particles and the porous magnetic core particles, a sample feeder for dry measurement “one shot dry sample conditioner Turbotrac” (manufactured by Nikkiso Co., Ltd.) was fitted. The feeding conditions of Turbotrac were set at an air flow of approximately 33 l/sec and a pressure of approximately 17 kPa using a dust collector as a vacuum source. The control of the measurement is automatically performed on a software program. The particle diameters are determined as a 50% particle diameter (D50) and a 90% particle diameter (D90), which are a cumulative value based on volume. The control and analysis are performed by using accessory software (Version 10.3.3-202D).

The measurement conditions are as follows.
SetZero Time: 10 seconds
Measurement Time: 10 seconds
Measurement Frequency: one time
Particle Refractive Index: 1.81
Particle Shape: Non-sphere
Measurement Upper Limit: 1408 μm
Measurement Lower Limit: 0.243 μm
Measurement Environment: Approximately 23° C./50% RH

<Measurement Method of Viscosity>

The viscosity after 60 seconds was measured using VP-500 manufactured by HAAKE.

The measurement apparatus and conditions are as follows.
Viscometer: Rotary viscometer Viscometer VT 550 (manufactured HAAKE)
Sensor System: NV cup/NV rotor
Rotation Number: 8.3 s⁻¹ (500 rpm)
Circulating Constant Temperature Bath: Open bath circulator DC 5-K20 (manufactured HAAKE)
Setting Temperature: 25° C.

<Average Circularity of Toner>

The average circularity of toner is measured with a flow-type particle image analyzer “FPIA-3000” (manufactured by SYSMEX CORPORATION) under the measurement and analysis conditions at the time of a calibration operation.

The measurement principle of a flow-type particle image analyzer “FPIA-3000” (manufactured by SYSMEX CORPORATION) is that flowing particles are photographed as a static image, and the image is analyzed. A sample added to a sample chamber is transferred to a flat sheath flow cell with a sample sucking syringe. The sample transferred to the flat sheath flow cell is sandwiched between sheath liquids to form a flat flow. The sample passing through the inside of the flat sheath flow cell is irradiated with stroboscopic light at intervals of 1/60 second and the flowing particles can be photographed as a static image. In addition, the particles are photographed in focus because the flow of the particles is flat. A particle image is photographed with a CCD camera, and the photographed image is subjected to image processing at an image processing resolution of 512×512 pixels (0.37×0.37 μm per pixel). Thereafter, each particle image is subjected to edge detection to measure the projected area S, circumferential length L, and the like of each particle image.

Subsequently, a circle-equivalent diameter and a circularity are determined using the projected area S and the circumferential length L of each particle image. The circle-equivalent diameter is defined as the diameter of a circle having the same area as that of the projected area of a particle image. The circularity C is defined as a value obtained by dividing the circumferential length of a circle determined from the circle-equivalent diameter by the circumferential length of a particle projected image and is calculated by the following equation.

The circularity C=2×(π×S)1/2/L

When a particle image is a circular shape, the circularity is 1.000. The larger the degree of unevenness of the periphery of the particle image, the smaller the value of the circularity. After the circularity of each particle is calculated, the circularity in a range of 0.2 to 1.0 is divided into 800 sections, and the arithmetic average value of the resulting circularity is calculated, which is defined as the average circularity.

A specific measuring method is as follows. Firstly, into a glass container is added approximately 20 ml of ion-exchanged water from which impure solid matters and the like have been previously removed. To the water, the following is added as a dispersant: approximately 0.2 ml of a diluted solution obtained by diluting approximately 3 times by mass “CONTAMINON N” (a 10% by mass aqueous solution of a neutral detergent with pH of 7 for washing a precision measuring apparatus, which includes a nonionic surfactant, an anionic surfactant and an organic builder, produced by Wako Pure Chemical Industries, Ltd.) with ion exchanged water. Further, to the resulting solution, the following is added: approximately 0.02 g of a measuring sample, followed by dispersion process for 2 minutes using an ultrasonic dispersion machine to prepare a dispersion liquid for measurement. In this case, the dispersion liquid is arbitrarily cooled so that the temperature is from 10° C. or more to 40° C. or less. As the ultrasonic dispersion machine, a desktop ultrasonic washing disperser with an oscillation frequency of 50 KHz and electrical power of 150 W (for example, “VS-150”, manufactured by Velvo-Clear Co., Ltd.) is used, and a predetermined amount of ion exchanged water is added in the water bath, to which approximately 2 ml of the CONTAMINON N is added.

The flow-type particle image analyzer equipped with a standard objective lens (at a magnification of 10) is used for the measurement, and a particle sheath “PSE-900A” (manufactured by Sysmex Corporation) is used as a sheath liquid. The dispersion liquid prepared in accordance with the procedure is introduced into the flow-type particle image analyzer, and the particle diameters of 3,000 particles are measured according to the total count mode in an HPF measuring mode. The average circularity of the toner is determined by setting a binarization threshold at the time of particle analysis to 85% and limiting the particle diameters to be analyzed to a circle-equivalent diameter of 1.985 μm or more and less than 39.69 μm or less.

Prior to the initiation of the measurement, automatic focusing is performed by using standard latex particles (obtained by diluting RESEARCH AND TEST PARTICLES Latex Microsphere Suspensions 5200A produced by Duke Scientific Corporation with ion exchanged water). Thereafter, focusing is preferably performed every two hours from the initiation of the measurement.

In addition, in the present Examples, a flow-type particle image analyzer was used which has been calibrated by Sysmex Corporation and received a calibration certificate issued by Sysmex Corporation. The measurement was performed under the measurement and analysis conditions at the time of receiving the calibration certificate except that particle diameters to be analyzed are limited to a circle-equivalent diameter of 1.985 μm or more and less than 39.69 μm.

<Weight Average Particle Diameter (D4) of Toner>

The weight average particle diameter (D4) of the toner is calculated as follows. As the measuring apparatus, a precise particle size distribution analyzer is used which is equipped with a aperture tube of 100 μm and is in accordance with a pore electric resistance method “Coulter Counter Multisizer 3” (registered trademark, manufactured by Beckman Coulter, Inc.). The setting of the measuring conditions and analysis of measured data are based on the dedicated software attached “Beckman Coulter Multisizer 3 Version 3.51” (manufactured by Beckman Coulter, Inc.). In addition, the measurement is made at 25,000 effective measuring channels.

As an electrolytic aqueous solution used for the measurement, an aqueous solution of sodium chloride having a concentration of approximately 1% by mass is used which is prepared by dissolving special grade sodium chloride in ion exchange water, for example, “ISOTON II” (manufactured by Beckman Coulter, Inc.).

In addition, before the measurement and analysis, the dedicated software was set up as follows.

In the “Change Display of Standard Measurement Method (SOM)” of the dedicated software, the total count number of the control mode is set at 50,000 particles, the measurement time is set at one time and the Kd value is set at a value obtained by using “standard particle of 10.0 μm” (manufactured by Beckman Coulter, Inc.). The threshold value and noise level are automatically set by pressing the threshold/noise measurement button. In addition, a check is entered at the “flush of the aperture tube after measurement” by setting the current at 1600 μA, the gain at 2 and the electrolytic aqueous solution at ISOTON II.

In the “Conversion Setting from Pulse to Particle Diameter” display of the dedicated software, the bin interval is set at the logarithm particle diameter, the particle diameter bin is set at the 256 particle diameter bin, and the particle diameter range is set at 2 μm to 60 μm.

A specific measurement method is as follows.

(1) Into a 250 ml round-bottom glass beaker dedicated to Multisizer 3, approximately 200 ml of the electrolytic aqueous solution is placed and the beaker is set in the sample stand, and stirring is conducted by rotating a stirrer rod in an anticlockwise direction at a speed of 24 rpm. Thereafter, dirt and air bubbles in the aperture tube are removed in advance by the “flush of aperture” function of the dedicated software.

(2) Into a 100 ml flat-bottom glass beaker, approximately 30 ml of the electrolytic aqueous solution is placed, followed by adding as a dispersant approximately 0.3 ml of a diluted solution obtained by diluting approximately 3 times by mass “CONTAMINON N” (a 10% by mass aqueous solution of a neutral detergent for washing a precision measuring apparatus with pH of 7, which includes a nonionic surfactant, an anionic surfactant and an organic builder, produced by Wako Pure Chemical Industries, Ltd.) with ion exchange water.

(3) An ultrasonic dispersing machine “Ultrasonic Dispersion System Tetra 150” (manufactured by Nikkaki-Bios Co., Ltd.) having an electric power of 120 W is prepared in which two oscillators having an oscillation frequency of 50 kHz are set in a state that their phases are shifted by 1800. Into the water bath of the ultrasonic dispersing machine, approximately 3.3 l of ion exchange water is placed, followed by adding approximately 2 ml of CONTAMINON N.

(4) The beaker of the above (2) is set in a fixing hole of the beaker of the ultrasonic dispersing machine and then the ultrasonic dispersing machine is operated. Thereafter, the height position of the beaker is adjusted so that the resonance state of the electrolytic aqueous solution level in the beaker is maximum.

(5) In a state in which an ultrasonic wave is applied to the electrolytic aqueous solution in the beaker of the above (4), approximately 10 mg of toner is dropwise added to the electrolytic aqueous solution and is dispersed. Thereafter, the ultrasonic dispersion process is further continued for 60 seconds. In addition, in carrying out the ultrasonic dispersion, the water temperature in the water bath is appropriately controlled so that the temperature is 10° C. or more and 40° C. or less.

(6) Into the round-bottom beaker of the above (1) set in the sample stand, the electrolytic aqueous solution of the above (5) in which toner has been dispersed is dropwise added by using a pipette, and is adjusted so that the measurement concentration is approximately 5%. Then, the measurement is made until the number of measured particles is 50,000.

(7) The measurement data are analyzed with the dedicated software attached to the apparatus to calculate the weight average particle diameter (D4). In addition, when the graph/% by volume is set with the dedicated software, an “average diameter” of the “analysis/volume statistical value (arithmetic average)” display is defined as a weight average particle diameter (D4).

<Measurement Method of Peak Molecular Weight (Mp), Number Average Molecular Weight (Mn) and Weight Average Molecular Weight (Mn) of Resin or Toner>

The peak molecular weight (Mp), number average molecular weight (Mn) and weight average molecular weight Mw) are measured by gel permeation chromatography (GPC) as follows.

Firstly, a sample is dissolved in tetrahydrofuran (THF) at room temperature over 24 hours. As the sample, a resin or a toner is used. And, the resulting solution is filtered through a solvent-resistant membrane filter having a pore diameter of 0.2 μm “Maeshoridisk” (manufactured by Tosoh Corporation) to prepare a sample solution. In addition, the sample is adjusted so that the concentration of the component soluble in THF is approximately 0.8% by mass. The measurement is carried out using the sample solution under the following conditions.
Apparatus: HCL 8120 GPC (Detector: RI) (manufactured by Tosoh Corporation)
Column: A combination of Shodex KF-801, 802, 803, 804, 805, 806, 807 (manufactured by Showa Denko K.K.)
Eluent: Tetrahydrofuran (THF)
Flow rate: 1.01 ml/min
Oven temperature: 40.0° C.
Sample Injection Volume: 0.10 ml

In calculating the molecular weight of the sample, a molecular weight calibration curve is used which has been prepared by using a standard polystyrene resin (for example, trade name “TSK standard polystyrene F-850, F-450, F-288, F-128, F-80, F-40, F-20, F-10, F-4, F-2, F-1, A-5000, A-2500, A-1000, A-500” (manufactured by Tosoh Corporation).

<Peak Temperature of Maximum Endothermic Peak of Wax and Glass Transition Temperature Tg of Binding Resin or Toner>

The peak temperature of the maximum endothermic peak of wax is measured by using a differential scanning calorimeter “Q 1000” (manufactured by TA Instruments Inc.) according to ASTM D3418-82.

The temperature at the detecting portion of the apparatus is corrected on the basis of melting points of indium and zinc, and the quantity of heat is corrected on the basis of the heat of fusion of indium.

Specifically, approximately 10 mg of wax is accurately weighed and placed in an aluminum pan, and an empty aluminum pan is used as a reference. The measurement is carried out at a temperature rising rate of 10° C./min. in the temperature range of 30 to 200° C. In addition, in the measurement, the temperature is increased once to 200° C., and then decreased to 30° C., and thereafter increased again. The maximum endothermic peak of a DSC curve in the range of 30° C. or more and 200° C. or less in the temperature rising step is defined as the endothermic peak of the wax in the present invention.

Further, as with the peak temperature measurement of the wax, the glass transition temperature (Tg) of the binding resin or the toner is measured by accurately weighing approximately 10 mg of the binding resin or the toner. Then, the change of specific heat is obtained in the range of 40° C. or more and 100° C. or less. An intersection of a straight line linking the middle points of base lines before and after the change of specific heat intersects and the DSC curve is defined as the glass transition temperature (Tg) of the binding resin or the toner.

<Method for Measuring Hydrophobicity Degree of External Additive>

The methanol titration test is an experimental test for confirming the degree of hydrophobicity of an inorganic powder whose particle surfaces have been made hydrophobic.

The measurement of the degree of hydrophobicity using methanol for evaluating the hydrophobicity of the external additive is carried out as follows.

To 50 ml of water in a conical flask, 0.2 g of an external additive is added. Methanol is dropwise added from a burette. At this time, the solution in the flask is constantly stirred with a magnetic stirrer. The completion of the precipitation of the external additive is confirmed by the fact that the whole amount is suspended in the solution. The degree of hydrophobicity is expressed as a volume percentage of methanol in the mixed solution of methanol and water at the time point when the precipitation is completed.

### Examples

Hereinafter, specific examples of the present invention will be described, but the present invention is not limited to these examples.

### Production Example 1 of Porous Magnetic Core Particles

Step 1 (Weighing and Mixing Step)

| | |
|---|---|
| Fe₂O₃ | 59.7% by mass |
| MnCO₃ | 34.4% by mass |
| Mg(OH)₂ | 4.8% by mass |
| SrCO₃ | 1.1% by mass |

The above ferrite raw materials were weighed, followed by pulverization and mixing by a dry-type ball mill using balls made of zirconia (a diameter (φ) of 10 mm) for 2 hours.

Step 2 (Preliminary Calcination Step)

After pulverization and mixing, the resulting particles were calcined using a burner-type incinerator in the air at 950° C. for 2 hours to prepare a preliminarily calcined ferrite.

The composition of the ferrite is shown below. (MnO)ₐ(MgO)_{b}(SrO)_{c}(Fe₂O₃)_{d}

In the above formula, a=0.39, b=0.11, c=0.01 and d=0.49.

Step 3 (Pulverization Step)

The preliminarily calcined ferrite was pulverized by a crusher to be approximately 0.5 mm in particle size and then water was added in an amount of 30 parts by mass based on 100 parts by mass of the preliminarily calcined ferrite, followed by pulverization by a wet-type ball mill using balls (a diameter (φ) of 10 mm) made of zirconia for 2 hours to obtain a ferrite slurry 1-1. The ferrite slurry 1-1 was divided into two parts. The half of the ferrite slurry 1-1 was further pulverized by a wet-type beads mill using beads (a diameter (φ) of 1.0 mm) made of zirconia for 3 hours to obtain a ferrite slurry 1-2. The ferrite slurry 1-1 and the ferrite slurry 1-2 were mixed by a wet-type beads mill using beads (a diameter (φ) of 1.0 mm) made of zirconia for 10 minutes to obtain a ferrite slurry 1 (a pulverized product of the preliminarily calcined particles).

The resulting pulverized product of the preliminarily calcined particles had a 50% particle diameter (D50) based on volume of 1.3 μm and a 90% particle diameter (D90) based on volume of 2.3 μm.

Step 4 (Granulation Step)

To the ferrite slurry, polyvinyl alcohol as a binder was added in an amount of 2.0 parts by mass based on 100 parts by mass of the preliminarily calcined ferrite, followed by granulation by means of a spray dryer (manufactured by Ohkawara Kakohki Co., Ltd.) to obtain spherical particles of approximately 36 μm.

Step 5 (Firing Step)

In order to control the calcination atmosphere, calcination was carried out under a nitrogen atmosphere (the oxygen concentration is 0.01% by volume or less) at a temperature of 1050° C. for 4 hours.

Step 6 (Sorting Step)

The aggregated particles were disintegrated, followed by removing coarse particles by using a sieve with an aperture of 250 μm to produce porous magnetic core particles 1.

### Production Example 2 of Porous Magnetic Core Particles

In the Production Example 1 of the porous magnetic core particles, the pulverizing time in the wet-type beads mill in Step 3 was changed to 2 hours. The resulting pulverized product of the preliminarily calcined ferrite has D50 of 1.4 μm and D90 of 3.0 μm. In addition, the calcination temperature in Step 5 was changed from 1050° C. to 1100° C. Except for the above, porous magnetic core particles 2 were obtained in the same manner as in Production Example 1 of the porous magnetic core particles.

### Production Example 3 of Porous Magnetic Core Particles

In the Production Example 1 of the porous magnetic core particles, the pulverizing time of the wet-type beads mill in Step 3 was changed from 3 hours to 2 hours. The resulting pulverized product of the preliminarily calcined ferrite has D50 of 1.7 μm and D90 of 5.0 μm. In addition, the calcination temperature in Step 5 was changed from 1050° C. to 1150° C. Except for the above, porous magnetic core particles 3 were obtained in the same manner as in Production Example 1 of the porous magnetic core particles.

### Production Example 4 of Porous Magnetic Core Particles

In the Production Example 1 of the porous magnetic core particles, the pulverization particle size by a crusher in Step 3 was changed from approximately 0.5 mm to approximately 0.3 mm, the balls of the wet-type ball mill was changed from balls (a diameter of 10 mm) made of zirconia to balls (a diameter of 10 mm) made of stainless steel, and the pulverizing time of the wet-type beads mill was changed from 3 hours to one hour in Step 3. The resulting pulverized product of the preliminarily calcined ferrite has D50 of 2.1 μm and D90 of 6.3 μm. In addition, the calcination temperature in Step 5 was changed from 1050° C. to 1100° C. Except for the above, porous magnetic core particles 4 were obtained in the same manner as in Production Example 1 of the porous magnetic core particles.

### Production Example 5 of Porous Magnetic Core Particles

In the Production Example 1 of the porous magnetic core particles, the balls of the wet-type ball mill in Step 3 was changed from balls (a diameter of 10 mm) made of zirconia to balls (a diameter of 10 mm) made of stainless steel, and the pulverizing time of the wet-type beads mill was changed from 3 hours to 2 hours in Step 3. The resulting pulverized product of the preliminarily calcined ferrite has D50 of 1.2 μm and D90 of 4.4 μm. In addition, in Step 5, the calcination temperature was changed from 1050° C. to 1200° C. and the calcination atmosphere was changed from a nitrogen atmosphere (the oxygen concentration is 0.01% by volume or less) to a nitrogen atmosphere (the oxygen concentration is 0.1% by volume). Except for the above, porous magnetic core particles 5 were obtained in the same manner as in Production Example 1 of the porous magnetic core particles.

### Production Example 6 of Porous Magnetic Core Particles

In the Production Example 1 of the porous magnetic core particles, the beads of the wet-type beads mill in Step 3 was changed from beads (a diameter of 1.0 mm) made of zirconia to beads (a diameter of 1.0 mm) made of aluminum. The resulting pulverized product of the preliminarily calcined ferrite has D50 of 2.4 μm and D90 of 4.2 μm. In addition, in Step 4, to the ferrite slurry, 2 parts by mass of sodium carbonate was added as a pore-adjusting agent together with 2 parts by mass of polyvinyl alcohol as a binder. Further, the calcination time in step 5 was changed from 4 hours to 2 hours. Except for the above, porous magnetic core particles 6 were obtained in the same manner as in Production Example 1 of the porous magnetic core particles.

### Production Example 7 of Porous Magnetic Core Particles

In the Production Example 1 of the porous magnetic core particles, the ratio of the ferrite raw materials in Step 1 was changed as follows.

| | |
|---|---|
| Fe₂O₃ | 62.8% by mass |
| MnCO₃ | 31.2% by mass |
| Mg(OH)₂ | 6.0% by mass |

The composition of the ferrite is shown below. (MnO)ₐ(MgO)_{b}(Fe₂O₃)_{c}

In the above formula, a=0.45, b=0.15 and c=0.40.

In Step 3, the pulverization particle size by a crusher was changed from approximately 0.5 mm to approximately 0.3 mm, the balls of the wet-type ball mill was changed from balls (a diameter of 10 mm) made of zirconia to balls (a diameter of 10 mm) made of stainless steel, the beads of the wet-type beads mill was changed from beads (a diameter of 1.0 mm) made of zirconia to beads (a diameter of 1.0 mm) made of stainless steel, and the pulverizing time was changed from 3 hours to 2 hours. The resulting pulverized product of the preliminarily calcined ferrite has D50 of 0.80 μm and D90 of 4.3 μm. The amount of polyvinyl alcohol added in Step 4 was changed to 2 parts by mass to 1 part by mass. In Step 5, the calcination temperature was changed from 1050° C. to 1200° C., the calcination atmosphere was changed from a nitrogen atmosphere (the oxygen concentration is 0.01% by volume or less) to a nitrogen atmosphere (the oxygen concentration is 1.0% by volume), and the calcination time was changed from 4 hours to 8 hours. Except for the above, porous magnetic core particles 7 were obtained in the same manner as in Production Example 1 of the porous magnetic core particles.

### Production Example 8 of Porous Magnetic Core Particles

In the Production Example 1 of the porous magnetic core particles, the ratio of the ferrite raw materials in Step 1 was changed as follows.

| | |
|---|---|
| Fe₂O₃ | 62.4% by mass |
| MnCO₃ | 30.5% by mass |
| Mg(OH)₂ | 6.4% by mass |
| SrCO₃ | 0.7% by mass |

The composition of the ferrite is shown below. (MnO)ₐ(MgO)_{b}(SrCO₃)_{c}(Fe₂O₃)_{d}

In the above formula, a=0.34, b=0.14, c=0.01 and D=0.51. In Step 3, the pulverization particle size by a crusher was changed from approximately 0.5 mm to approximately 1.0 mm, the balls of the wet-type ball mill was changed from balls (a diameter of 10 mm) made of zirconia to balls (a diameter of 10 mm) made of aluminum, and the pulverizing time was changed from 2 hours to one hour. The beads of the wet-type beads mill was changed from beads (a diameter of 1.0 mm) made of zirconia to beads (a diameter of 1.0 mm) made of alumina. The resulting pulverized product of the preliminarily calcined ferrite has D50 of 4.8 μm and D90 of 6.8 μm. In Step 4, the amount of polyvinyl alcohol was changed to 2 parts by mass to 5 parts by mass. In Step 5, the calcination temperature was changed from 1050° C. to 1000° C. and the calcination atmosphere was changed from a nitrogen atmosphere (the oxygen concentration is 0.01% by volume or less) to a nitrogen atmosphere (the oxygen concentration is 0.5% by volume). Except for the above, porous magnetic core particles 8 were obtained in the same manner as in Production Example 1 of the porous magnetic core particles.

### Production Example 9-1 of Ferrite Slurry

Step 1

| | |
|---|---|
| Fe₂O₃ | 59.7% by mass |
| MnCO₃ | 34.4% by mass |
| Mg(OH)₂ | 4.8% by mass |
| SrCO₃ | 1.1% by mass |

The above ferrite raw materials were weighed and then water was added in an amount of 30 parts by mass based on 100 parts by mass of the ferrite raw materials, followed by wet mixing by a wet-type ball mill using balls made of zirconia (a diameter (φ) of 10 mm) for 2 hours.

Step 2

After pulverization and mixing, the resulting particles were calcined in the air at 900° C. for 2 hours to prepare a preliminarily calcined ferrite.

The composition of the ferrite is shown below. (MnO)ₐ(MgO)_{b}(SrO)_{c}(Fe₂O₃)_{d}

In the above formula, a=0.39, b=0.11, c=0.01 and d=0.49.

Step 3

The preliminarily calcined ferrite was pulverized by a crusher to be approximately 0.5 mm in particle size and then water was added in an amount of 30 parts by mass based on 100 parts by mass of the preliminarily calcined ferrite, followed by pulverization by a wet-type beads mill using balls made of zirconia (a diameter (φ) of 10 mm) for 3 hours. Thereafter, the slurry was pulverized by a wet-type beads mill using beads (a diameter (φ) of 1.0 mm) made of zirconia for 3 hours, followed by pulverization by a wet-type beads mill using beads (a diameter (φ) of 1.0 mm) made alumina for 6 hours to obtain a ferrite slurry (a pulverized product of the preliminarily calcined ferrite) 9-1. The resulting pulverized product of the preliminarily calcined ferrite had D50 of 1.4 μm and D90 of 1.8 μm.

### Production Example 9-2 of Ferrite Slurry

In the Production Example 9-1, the balls of the wet-type ball mill in step 3 was changed from balls (a diameter of 10 mm) made of zirconia to balls (a diameter of 10 mm) made of stainless steel and the pulverizing time was changed from 2 hours to one hour. In addition, the pulverizing time of the wet-type beads mill using beads (a diameter of 1.0 mm) made of zirconia was changed from 3 hours to one hour. Except for the above, a ferrite slurry (a pulverized product of the preliminarily calcined ferrite) 9-2 was obtained in the same manner as in Production Example 9-1 of the ferrite slurry. The resulting pulverized product of the preliminarily calcined ferrite had D50 of 2.8 μm and D90 of 3.8 μm.

### Production Example 9 of Porous Magnetic Core Particles

Step 4

50 parts by mass of the ferrite slurry 9-1 was added as a preliminarily calcined ferrite, 50 parts by mass of the ferrite slurry 9-2 was added as a preliminarily calcined ferrite, and water was added in an amount of 50 parts by mass based on 100 parts by mass of the preliminarily calcined ferrite, followed by mixing by means of a wet-type ball mill using balls (a diameter of 10 mm) made of alumina for 10 minutes. To the mixture, polyvinyl alcohol as a binder was added in an amount of 2.0 parts by mass based on 100 parts by mass of the preliminarily calcined ferrite, followed by granulation by a spray dryer (manufacture by Ohkawara Kakohki Co., Ltd.) to produce spherical particles of approximately 40 μm.

Step 5

In order to control the calcination atmosphere, calcination was carried out under a nitrogen atmosphere (the oxygen concentration is 0.01% by volume or less) at a temperature of 1000° C. for 4 hours.

Step 6

The aggregated particles were disintegrated, followed by removing coarse particles using a sieve with an aperture of 250 μm to produce porous magnetic core particles 9.

### Production Example 10 of Porous Magnetic Core Particles

In the Production Example 8 of porous magnetic core particles, the pulverizing particle size by a crusher in step 3 was changed approximately from 1.0 mm to approximately 0.3 mm, the balls of the wet-type ball mill was changed from balls (a diameter of 10 mm) made of alumina to balls (a diameter of 10 mm) made of stainless steel and the pulverizing time was changed from one hour to 3 hours. The beads of the wet-beads mill was changed from beads (a diameter of 1.0 mm) made of alumina to beads (a diameter of 1.0 mm) made of stainless steel and the pulverizing time was changed from 3 hours to 2 hours. The resulting pulverized product of the preliminarily calcined ferrite had D50 of 0.4 μm and D90 of 2.3 μm. The amount of polyvinyl alcohol added in step 4 was changed from 5.0 parts by mass to 1.0 part by mass.

The calcination temperature in step 5 was changed from 1000° C. to 1250° C. Except for the above, porous magnetic core particles 10 were obtained in the same manner as in Production Example 8 of porous magnetic core particles.

### Production Example 11 of Porous Magnetic Core Particles

In the Production Example 8 of porous magnetic core particles, the pulverizing time of the wet-beads mill in step 3 was changed from 3 hours to 2 hours. The resulting pulverized product of the preliminarily calcined ferrite had D50 of 5.6 μm and D90 of 7.8 μm. The amount of polyvinyl alcohol added in step 5 was changed from 5.0 parts by mass to 10.0 parts by mass. In step 5, the calcination time was changed from 4 hours to 2 hours and the calcination atmosphere was changed from a nitrogen atmosphere (the oxygen concentration is 0.01% by volume or less) to a nitrogen atmosphere (the oxygen concentration is 1.0% by volume). Except for the above, porous magnetic core particles 11 were obtained in the same manner as in Production Example 8 of the porous magnetic core particles.

### Production Example 12 of Porous Magnetic Core Particles

In the Production Example 8 of porous magnetic core particles, the pulverizing particle size by a crusher in step 3 was changed approximately from 1.0 mm to approximately 0.3 mm, the balls of the wet-type ball mill was changed from balls (a diameter of 10 mm) made of alumina to balls (a diameter of 10 mm) made of stainless steel, the beads of the wet-beads mill was changed from beads (a diameter of 1.0 mm) made of alumina to beads (a diameter of 1.0 mm) made of stainless steel and the pulverizing time was changed from 3 hours to 4 hours.

The ferrite slurry was not divided into two parts in pulverization by a wet-type beads mill, but the total amount was subjected to pulverization by a wet-type beads mill.

The resulting pulverized product of the preliminarily calcined ferrite has D50 of 1.5 μm and D90 of 1.9 μm. The amount of polyvinyl alcohol added in step 4 was changed from 5.0 parts by mass to 2.0 parts by mass.

In step 5, the calcination temperature was changed from 1000° C. to 1100° C. and the calcination atmosphere was changed from a nitrogen atmosphere (the oxygen concentration is 0.5% by volume) to a nitrogen atmosphere (the oxygen concentration is 1.0% by volume). Except for the above, porous magnetic core particles 12 were obtained in the same manner as in Production Example 8 of the porous magnetic core particles.

### Production Example 13 of Porous Magnetic Core Particles

In the Production Example 10 of porous magnetic core particles, the amount of polyvinyl alcohol added in step 4 was changed from 5.0 parts by mass to 1.5 parts by mass and the calcination temperature in step 5 was changed from 1000° C. to 1220° C. Except for the above, porous magnetic core particles 13 were obtained in the same manner as in Production Example 10 of porous magnetic core particles.

### Production Example 14 of Porous Magnetic Core Particles

In the Production Example 11 of porous magnetic core particles, the addition amount of polyvinyl alcohol in step 4 was changed from 5.0 parts by mass to 9.0 parts by mass.

The calcination temperature in step 5 was changed from 1000° C. to 1220° C. Except for the above, porous magnetic core particles 14 were obtained in the same manner as in Production Example 11 of porous magnetic core particles.

### Production Example 1 of Magnetic Core Particles

Step 1

| | |
|---|---|
| Fe₂O₃ | 71.0% by mass |
| CuO | 12.5% by mass |
| ZrO | 16.5% by mass |

The above ferrite raw materials were weighed, followed by pulverization and mixing by a dry-type ball mill using balls made of zirconia (a diameter (φ) of 10 mm) for 2 hours.

Step 2

After pulverization and mixing, the resulting particles were calcined in the air at 950° C. for 2 hours to prepare a preliminarily calcined ferrite.

The composition of the ferrite is shown below. (CuO)ₐ(ZnO)_{b}(Fe₂O₃)_{c}

In the above formula, A=0.20, b=0.25 and c=0.55

Step 3

The preliminarily calcined ferrite was pulverized by a crusher to be approximately 0.5 mm in particle size and then water was added in an amount of 30 parts by mass based on 100 parts by mass of the preliminarily calcined ferrite, followed by pulverization by a wet-type ball mill using balls (a diameter (φ) of 10 mm) made of stainless steel for 6 hours to produce a pulverized product of the preliminarily calcined ferrite. The resulting pulverized product of the preliminarily calcined ferrite had D50 of 0.5 μm and D90 of 2.8 μm.

Step 4

To the ferrite slurry, polyvinyl alcohol as a binder was added in an amount of 2.0 parts by mass based on 100 parts by mass of the preliminarily calcined ferrite, followed by granulation by a spray dryer (manufactured by Ohkawara Kakohki Co., Ltd.) to produce spherical particles.

Step 5

The spherical particles were calcined in the air at 1300° C. for 4 hours.

Step 6

The aggregated particles were disintegrated, followed by removing coarse particles using a sieve with an aperture of 250 μm to produce porous magnetic core particles 1.

The physical properties of various magnetic core particles are shown in Table 1.

TABLE 1

| | | Pulverized | | | | | | | | |
|---|---|---|---|---|---|---|---|---|---|---|
| | | product of | | | | | | | | |
| | | preliminarily | | | | Measurement | | | | |
| | | calcined | | Core particles | | results by mercury intrusion method | | | | |
| | | ferrite | | | Breakdown | Peaktop pore | P2 pore | | | |
| | | D50 | D90 | D50 | electric field | diameter | diameter | P1 | P2 | |
| | | [μm] | [μm] | [μm] | intensity [V/cm] | [μm] | [μm] | [ml/g] | [ml/g] | P2/P1 |
| Porous magnetic | | 3.2 | 5.4 | 34.2 | 560 | 1.09 | 2.84 | 0.40 | 0.044 | 0.11 |
| core particles 1 | | | | | | | | | | |
| Porous magnetic | | 2.6 | 5.8 | 31.8 | 820 | 0.96 | 2.47 | 0.28 | 0.039 | 0.14 |
| core particles 2 | | | | | | | | | | |
| Porous magnetic | | 2.1 | 6.3 | 37.4 | 430 | 0.96 | 2.47 | 0.14 | 0.029 | 0.21 |
| core particles 3 | | | | | | | | | | |
| Porous magnetic | | 3.1 | 9.4 | 33.2 | 620 | 1.09 | 2.16 | 0.36 | 0.083 | 0.23 |
| core particles 4 | | | | | | | | | | |
| Porous magnetic | | 1.8 | 6.8 | 28.7 | 1800 | 0.96 | 2.84 | 0.12 | 0.013 | 0.11 |
| core particles 5 | | | | | | | | | | |
| Porous magnetic | | 4.3 | 6.8 | 41.2 | 380 | 1.25 | 2.16 | 0.44 | 0.106 | 0.24 |
| core particles 6 | | | | | | | | | | |
| Porous magnetic | | 1.2 | 5.4 | 48.2 | 2550 | 0.84 | 2.84 | 0.07 | 0.020 | 0.29 |
| core particles 7 | | | | | | | | | | |
| Porous magnetic | | 4.8 | 6.8 | 22.3 | 2060 | 1.42 | 2.16 | 0.48 | 0.034 | 0.07 |
| core particles 8 | | | | | | | | | | |
| Porous magnetic | Ferrite slurry 9-1 | 1.4 | 1.8 | 37.5 | 1220 | 0.96 | 2.84 | 0.43 | 0.103 | 0.24 |
| core particles 9 | Ferrite slurry 9-2 | 4.3 | 5.8 | | | | | | | |
| Porous magnetic | | 0.9 | 4.6 | 19.8 | 2120 | 0.74 | 2.84 | 0.03 | 0.001 | 0.03 |
| core particles 10 | | | | | | | | | | |
| Porous magnetic | | 5.6 | 7.8 | 54.3 | 2450 | 1.64 | 2.16 | 0.57 | 0.194 | 0.34 |
| core particles 11 | | | | | | | | | | |
| Porous magnetic | | 3.4 | 4.5 | 35.1 | 2700 | 1.09 | 2.16 | 0.04 | 0.001 | 0.02 |
| core particles 12 | | | | | | | | | | |
| Porous magnetic | | 0.9 | 4.6 | 20.2 | 2240 | 0.85 | 2.78 | 0.05 | 0.002 | 0.03 |
| core particles 13 | | | | | | | | | | |
| Porous magnetic | | 5.6 | 7.8 | 52.3 | 2350 | 1.55 | 2.15 | 0.49 | 0.142 | 0.29 |
| core particles 14 | | | | | | | | | | |
| Magnetic core | | 0.5 | 2.8 | 36.4 | No occurrence of | 1.89 | 2.16 | 0.01 | 0.006 | 0.58 |
| particles 1 | | | | | breakdown | | | | | |

### Production Example 1 of Magnetic Carrier

Preparation of Resin Solution

Resin Solution 1

| | |
|---|---|
| Straight Silicone (SR 2411, Dow Corning Toray | 20.0 parts by mass |
| Co., Ltd.) (Viscosity in 20% by mass of | |
| toluene solution: 1.1 × 10⁻⁶ m²/sec) | |
| γ-Aminopropyltriethoxysilane | 0.5 parts by mass |
| Toluene | 79.5 parts by mass |

The above raw materials were mixed using a ball mill (soda glass balls with a diameter of 10 mm) for one hour to prepare a resin solution 1.

Resin Solution 2

| Polymethacrylate polymer (Mw = 66000) | 5.0 | parts by mass |
|---|---|---|
| (Viscosity in 20% by mass of toluene solution: | | |
| 8.4 × 10⁻⁵ m²/sec) | | |
| Bontron P51 (Orient Chemical Industries Ltd.) | 2.0% by mass | |
| Toluene | 93.0 | parts by mass |

The above raw materials were mixed using a beads mill (zirconia beads with a diameter of 1.0 mm) for 3 hours to prepare a resin solution 2.

Resin Solution 3

| | |
|---|---|
| Straight Silicone (SR 2410, Dow Corning Toray | 20.0 parts by mass |
| Co., Ltd.) (Viscosity in 20% by mass of toluene | |
| solution: 2.9 × 10⁻⁶ m²/sec) | |
| γ-Aminopropyltriethoxysilane | 0.3 parts by mass |
| Toluene | 79.7 parts by mass |

The above raw materials were mixed using a ball mill (soda glass balls with a diameter of 10 mm) for one hour to prepare a resin solution 3.

Resin Solution 4

| | |
|---|---|
| Straight Silicone (SR 2410, Dow Corning | 20.0 parts by mass |
| Toray Co., Ltd.) (Viscosity in 20% by mass of | |
| toluene solution: 2.9 × 10⁻⁶ m²/sec) | |
| γ-Aminopropyltriethoxysilane | 0.3 parts by mass |
| Guanamine resin solvent | 3.0 parts by mass |
| (MYCOAT 106, manufactured by Scitex | |
| Corporation Ltd.) | |
| Toluene | 76.7 parts by mass |

The above raw materials were mixed using a ball mill (soda glass balls with a diameter of 10 mm) for one hour to prepare a resin solution 4.

### Production Example of Magnetic Carrier 1

### Step Example 1 (Resin Filling Step Example 1)

In a versatile mixer (manufactured by Dulton Co., Ltd.), 100.0 parts by mass of the porous magnetic core particles 1 was placed, followed by stirring under reduced pressure while heating at 80° C. Subsequently, to the mixer, the resin solution 1 was added so that the resin component was 15 parts by mass based on the porous magnetic core particles 1, followed by heating for 2 hours to remove the solvent. The resulting sample was transferred to a JULIA mixer (manufactured by Tokuju Corporation) and was subjected to heat treatment under a nitrogen atmosphere at 200° C. for 2 hours, followed by classification with a mesh having an opening of 70 μm to produce filled cores 1.

### Step Example 2 (Resin Coating Step 1)

To a Nauta mixer (manufactured by Hosokawa Micron Co., Ltd.), 100.0 parts by mass of the filled cores 1 was added, and further the resin solution 3 was added so that the resin component is 1.0 parts by mass. The mixture was heated under reduced pressure at 70° C., and mixed at 1.7 S⁻¹ (100 rpm), followed by removing the solvent and performing coating operation over 4 hours. Thereafter, the resulting sample was transferred to a JULIA mixer (manufactured Tokuju Corporation) and was subjected to heat treatment under a nitrogen atmosphere at 200° C. for 2 hours, followed by classification with a mesh having an opening of 70 μm to produce a magnetic carrier 1.

### Production Example of Magnetic Carrier 6

### Step Example 3 (Resin Filling Step Example 2)

To a versatile mixer (manufactured by Dulton Co., Ltd.), 100.0 parts by mass of the porous magnetic core particles 2 was added, followed by stirring under reduced pressure while heating at 80° C. Subsequently, to the mixer the resin solution 1 was added so that the resin component was 18 parts by mass based on the porous magnetic core particles 2, followed by heating for 2 hours to remove the solvent. The resulting sample was transferred to a JULIA mixer (manufactured by Tokuju corporation) and was subjected to heat treatment under a nitrogen atmosphere at 110° C. for 2 hours, followed by classification with a mesh having an opening of 70 μm to produce filled cores 6.

### Production Example of Magnetic Carrier 8

### Step Example 4 (Resin Filling Step Example 3)

To a Nauta mixer (manufactured by Hosokawa Micron Co., Ltd.), 100.0 parts by mass of the porous magnetic core particles 5 was added, and further the resin solution was added so that the resin component was 3.0 parts by mass. The mixture was heated under reduced pressure at 70° C., and mixed at 1.7 S⁻¹ (100 rpm), followed by removing the solvent and performing coating operation over 4 hours. Thereafter, the resulting sample was transferred to a JULIA mixer (manufactured by Tokuju Corporation) and was subjected to heat treatment under a nitrogen atmosphere at 200° C. for 2 hours, followed by classification with a mesh having an opening of 70 μm to produce a magnetic carrier 8.

### Production Example of Magnetic Carriers 2 to 5, 7 and 9 to 17

Magnetic carriers 2 to 5, 7, and 9 to 17 were obtained in the same manner as in the above Production Examples of Magnetic Carriers except for changing the core particles, the kind and amount of the filling resin, the kind and amount of the coating resin and the step, as shown in Table 2.

TABLE 2

| | | | Resin filling step | | | | | |
|---|---|---|---|---|---|---|---|---|
| | | D50 | Resin | Amount (in terms of | | Resin coating step | | |
| | Core particles | [μm] | solution | resin) | Step | Resin | Amount | Step |
| Magnetic carrier 1 | Porous magnetic | 35.4 | Resin | 15.0 parts by mass | Step Example 1 | Resin solution 3 | 1.0 part by mass | Step |
| | core particles 1 | | solution 1 | | | | | Example 2 |
| Magnetic carrier 2 | Porous magnetic | 32.8 | Resin | 10.0 parts by mass | Step Example 1 | Resin solution 4 | 0.5 parts by mass | Step |
| | core particles 2 | | solution 1 | | | | | Example 2 |
| Magnetic carrier 3 | Porous magnetic | 43.4 | Resin | 8.0 parts by mass | Step Example 1 | Resin solution 3 | 0.5 parts by mass | Step |
| | core particles 3 | | solution 1 | | | | | Example 2 |
| Magnetic carrier 4 | Porous magnetic | 35.6 | Resin | 10.0 parts by mass | Step Example 1 | Resin solution 3 | 0.5 parts by mass | Step |
| | core particles 4 | | solution 1 | | | | | Example 2 |
| Magnetic carrier 5 | Porous magnetic | 40.4 | Resin | 8.0 parts by mass | Step Example 1 | Resin solution 3 | 0.5 parts by mass | Step |
| | core particles 9 | | solution 1 | | | | | Example 2 |

| | | | | | | |
|---|---|---|---|---|---|---|
| Magnetic carrier 6 | Porous magnetic | 31.2 | Resin | 18.0 parts by mass | Step Example 1 | No implementation of resin coating step |
| | core particles 9 | | solution 1 | | | |
| Magnetic carrier 7 | Porous magnetic | 48.5 | Resin | 18.0 parts by mass | Step Example 3 | No implementation of resin coating step |
| | core particles 2 | | solution 2 | | | |
| Magnetic carrier 8 | Porous magnetic | 54.3 | Resin | 3.0 parts by mass | Step Example 4 | No implementation of resin coating step |
| | core particles 5 | | solution 2 | | | |
| Magnetic carrier 9 | Porous magnetic | 26.4 | Resin | 18.0 parts by mass | Step Example 3 | No implementation of resin coating step |
| | core particles 6 | | solution 2 | | | |
| Magnetic carrier 10 | Porous magnetic | 60.4 | Resin | 5.0 parts by mass | Step Example 3 | No implementation of resin coating step |
| | core particles 7 | | solution 2 | | | |
| Magnetic carrier 11 | Porous magnetic | 18.6 | Resin | 20.0 parts by mass | Step Example 3 | No implementation of resin coating step |
| | core particles 8 | | solution 2 | | | |
| Magnetic carrier 12 | Porous magnetic | 34.5 | Resin | 4.0 parts by mass | Step Example 3 | No implementation of resin coating step |
| | core particles 10 | | solution 2 | | | |
| Magnetic carrier 13 | Porous magnetic | 37.6 | Resin | 25.0 parts by mass | Step Example 3 | No implementation of resin coating step |
| | core particles 11 | | solution 2 | | | |
| Magnetic carrier 14 | Porous magnetic | 31.5 | Resin | 4.0 parts by mass | Step Example 3 | No implementation of resin coating step |
| | core particles 12 | | solution 1 | | | |

| | | | | | | |
|---|---|---|---|---|---|---|
| Magnetic carrier 15 | Magnetic core | 38.6 | No implementation of resin filling step | Resin solution 3 | 1.0 part by mass | Step |
| | particles 1 | | | | | Example 2 |

| | | | | | | |
|---|---|---|---|---|---|---|
| Magnetic carrier 16 | Porous magnetic | 35.1 | Resin | 4.0 parts by mass | Step Example 3 | No implementation of resin coating step |
| | core particles 13 | | solution 2 | | | |
| Magnetic carrier 17 | Porous magnetic | 37.4 | Resin | 25.0 parts by mass | Step Example 3 | No implementation of resin coating step |
| | core particles 14 | | solution 2 | | | |

### Toner Production Example 1

The following materials were weighed in a reaction vessel equipped with a cooling tube, an agitator and a nitrogen introduction tube.

| | |
|---|---|
| Terephthalic acid | 299 parts by mass |
| Trimellitic anhydride | 19 parts by mass |
| Polyoxypropylene(2.2)-2,2-bis(4- | 747 parts by mass |
| hydroxyphenyl)propane | |
| Titaniumdihydroxybis(triethanolaminate) | 1 part by mass |

Thereafter, reaction was carried out by heating at 200° C. for 10 hours while introducing nitrogen and removing water generated, and the reaction was continued under reduced pressure of 10 mmHg for one hour to synthesize a resin 1. The resin 1 had a weight average molecular weight (Mw) of 6000, a number average molecular weight (Mn) of 2400 and a peak molecular weight (Mp) of 2800, as determined by GPC.

The following materials were weighed in a reaction vessel equipped with a cooling tube, an agitator and a nitrogen introduction tube.

| | |
|---|---|
| Terephthalic acid | 332 parts by mass |
| Polyoxypropylene(2.2)-2,2-bis(4- | 996 parts by mass |
| hydroxyphenyl)propane | |
| Titaniumdihydroxybis(triethanolaminate) | 1 part by mass |

Thereafter, reaction was carried out by heating at 220° C. for 10 hours while introducing nitrogen and removing water generated.

Further, 96 parts by mass of trimellitic anhydride was added and the reaction was continued by heating to 180° C. for 2 hours to synthesize a resin 2. The resin 2 had a weight average molecular weight (Mw) of 84000, a number average molecular weight (Mn) of 6200, a peak molecular weight (Mp) of 12000, as determined by GPC, and a glass transition point (Tg) of 62° C.

| | |
|---|---|
| Resin 1 | 50.0 parts by mass |
| Resin 2 | 50.0 parts by mass |
| Refined normal paraffin (DSC maximum | 5.0 parts by mass |
| endothermic peak temperature: 70° C.) | |
| C.I. Pigment Blue 15:3 | 5.0 parts by mass |

The above materials were sufficiently mixed by a Henschel mixer (FM-75 Type, manufactured by Mitsui Miike Engineering Corporation), followed by kneading by a twin-screw extruder (PCM-Type, manufactured by Ikegai Corporation) set at 130° C. The resulting kneaded product was cooled and then was roughly pulverized with a hammer mill into a powder having a particle diameter of 1 mm or less, to thereby obtain a roughly pulverized product. The resulting roughly pulverized product was finely pulverized with a collision airflow pulverizer using high pressure gas.

Subsequently, the finely pulverized product was subjected to surface modification by the surface modification apparatus shown in FIG. 1. The surface modification was carried out under the conditions of a raw material feed rate of 2.0 kg/hr and a discharge temperature of hot air at 220° C. Thereafter, toner particles were obtained by simultaneously classifying and removing the resulting fine particles or coarse particles by a pneumatic separator (Elbow Jet Lab EJ-L3, manufactured by Nittetsu Mining Co., Ltd.) utilizing a Coanda effect.

A toner 1 was obtained by externally mixing 1.0 part by mass of titanium oxide fine powder having a number average particle size of 40 nm treated with i-butyltrimethoxysilane to have a hydrophobicity degree of 50%, and 0.5 parts by mass of amorphous silica fine powder having a number average particle size of 110 nm treated with hexamethyldisilazane to have a hydrophobicity degree of 85% as inorganic fine particles with 100.0 parts by mass of the resulting toner particles.

### Toner Production Example 2

In Production Example 1 of Toner, 2.0 parts by mass of rice wax (DSC maximum endothermic peak temperature: 79° C.) was used instead of 5.0 parts by mass of refined normal paraffin wax (DSC maximum endothermic peak temperature: 70° C.). The resulting finely pulverized product was not subjected to surface modification and fine particles or coarse particles were classified and removed simultaneously by a pneumatic separator (Elbow Jet Lab EJ-L3, manufactured by Nittetsu Mining Co., Ltd.).

Except for the above, a toner 2 was obtained in the same manner as in Toner Production Example 1.

### Toner Production Example 3

| | |
|---|---|
| Styrene | 78.4 parts by mass |
| n-Butyl Acrylate | 20.8 parts by mass |
| Methacrylic Acid | 2.0 parts by mass |

The above materials were added to a reaction vessel and the resulting mixed solution was heated to a temperature of 110° C. To the mixed solution, a solution was dropwise added in a nitrogen atmosphere over approximately 30 minutes, with the solution having been obtained by dissolving 1 part of tert-butylhydroperoxide, which is a radical polymerization initiator, in 10 parts of xylene. Further, the resulting mixed solution was desolvated under reduced pressure while heating to prepare a resin 3. The resin 3 had a weight average molecular weight (Mw) of 35,000, a number average molecular weight (Mn) of 8000 and a peak molecular weight (Mp) of 12,000, as determined by GPC, and a glass transition point (Tg) of 58° C.

| | |
|---|---|
| Resin 3 | 100.0 parts by mass |
| Refined normal paraffin (DSC maximum | 5.0 parts by mass |
| endothermic peak temperature: 70° C.) | |
| C.I. Pigment Blue 15:3 | 5.0 parts by mass |
| 3,5-Di-t-butylsalicylic acid aluminum compound | 1.0 part by mass |

The above materials were sufficiently mixed by a Henschel mixer (FM-75 Type, manufactured by Mitsui Miike Engineering Corporation), followed by kneading by means of a twin-screw extruder (PCM-Type, manufactured by Ikegai Corporation) set at 130° C. The resulting kneaded product was cooled and then was roughly pulverized with a hammer mill into a powder having a particle diameter of 1 mm or less to thereby obtain a roughly pulverized product. The resulting roughly pulverized product was finely pulverized with a collision airflow pulverizer using high pressure gas.

Subsequently, the finely pulverized product was subjected to surface modification treatment using Faculty (manufactured by Hosokawa Micron Co., Ltd.) while removing fine particles, thereby obtaining toner particles.

A toner 3 was obtained by externally mixing 1.0 part by mass of titanium oxide fine powder having a number average particle size of 40 nm treated with i-butyltrimethoxysilane to have a hydrophobicity degree of 50%, and 0.5 parts by mass of amorphous silica fine powders having a number average particle size of 110 nm treated with hexamethyldisilazane to have a hydrophobicity degree of 85% as inorganic fine particles with 100.0 parts by mass of the resulting toner particles.

### Toner Production Example 4

To 710 parts by mass of ion exchanged water, 450 parts by mass of a 0.1 M-Na₃PO₄ aqueous solution was added and the mixture was heated at 65° C., followed by stirring at 200 s⁻¹ (12000 rpm) using a TK-type homomixer (manufactured by PRIMIX Corporation). To the resulting mixture, 68 parts by mass of 1.0 M CaCl₂ aqueous solution was gradually added to prepare an aqueous medium containing Ca₃(PO₄)₂.

| | |
|---|---|
| Styrene | 80.0 parts by mass |
| n-Butylacrylate | 20.0 parts by mass |
| C.I. Pigment Blue 15:3 (colorant) | 6.0 parts by mass |
| 3,5-Di-t-butylsalicylic acid aluminum compound | 1.0 part by mass |
| Polyester (polymerized from bisphenol A, | 7.0 parts by mass |
| terephthalic acid and trimellitic anhydride, | |
| Mp = 8000) | |
| Behenyl behenate (DSC maximum endothermic | 14.0 parts by mass |
| temperature: 72° C.) | |

The above materials were heated at 60° C., followed by uniformly dissolving and dispersing at 167 s⁻¹ (10,000 rpm) using a TK-type homomixer (manufactured by PRIMIX Corporation). In the resulting mixture 7.0 parts by mass of 2,2′-azobis(2,4-dimethylvaleronitrile) as a polymerization initiator was dissolved to prepare a monomer composition.

The monomer composition was placed in an aqueous medium, followed by stirring at 167 s⁻¹ (10,000 rpm) by a TK-type homomixer under a nitrogen atmosphere at 60° C. for 10 minutes to granulate the monomer composition. Thereafter, the monomer composition was heated at 80° C. while stirring by a paddle stirring blade and allowed to react for 10 hours. After completion of the polymerization reaction, the residual monomers were remove by distillation. After cooling, hydrochloric acid was added to dissolve Ca₃(PO₄)₂ and the like, and then the reaction product was washed with water and dried to produce toner particles.

A toner 4 was obtained by externally mixing 1.0 part by mass of titanium oxide fine powder having a number average particle size of 40 nm treated with i-butyltrimethoxysilane to have a hydrophobicity degree of 50%, and 0.5 parts by mass of amorphous silica fine powder having a number average particle size of 110 nm treated with hexamethyldisilazane to have a hydrophobicity degree of 85% as inorganic fine particles with 100.0 parts by mass of the resulting toner particles.

The toner 4 had a weight average molecular weight (Mw) of 210,000, a number average molecular weight (Mn) of 7000, as determined by GPC, and a peak molecular weight (Mp) of 31,000.

### Production Example 5 of Toner

### Dispersion Solution A:

| | |
|---|---|
| Styrene | 350.0 parts by mass |
| n-Butylacrylate | 100.0 parts by mass |
| Acrylic acid | 25.0 parts by mass |
| t-dodecylmercaptan | 10.0 parts by mass |

The above materials were mixed and dissolved to prepare a monomer mixture A.

| | |
|---|---|
| Paraffin wax dispersion (DSC maximum | 100.0 parts by mass |
| endothermic temperature: 72° C.; | |
| solid matter concentration: 30%, | |
| dispersion particle diameter: 0.14 μm) | |
| Anionic surfactant (Neogen SC, produced by | 1.2 parts by mass |
| Daiichi Kogyo Seiyaku Co., Ltd.) | |
| Nonionic surfactant (Nonipol 400, | 0.5 parts by mass |
| produced by Sanyo Chemical Industries Ltd.) | |
| Ion exchanged water | 1530.0 parts by mass |

The above materials were dispersed in a flask and heating was started under substitution with nitrogen. When the solution was heated to 65° C., a solution obtained by dissolving 6.5 parts by mass of potassium persulfate in 350 parts by mass of ion exchanged water was added thereto. While maintaining the solution temperature to be 70° C., the monomer mixture A was added and stirred, and emulsion polymerization was continued for 5 hours by raising the resulting solution temperature to 80° C. Thereafter, the resulting solution was cooled to 40° C. and then filtered with a filter to prepare a dispersion solution A.

### Dispersion Solution B:

| | |
|---|---|
| Styrene | 350.0 parts by mass |
| n-Butylacrylate | 100.0 parts by mass |
| Acrylic acid | 30.0 parts by mass |

The above materials were mixed and dissolved to prepare a monomer mixture B.

| | |
|---|---|
| Fischer-Tropsch wax dispersion (DSC | 100.0 parts by mass |
| maximum endothermic temperature: 105° C.; | |
| solid matter concentration: 30%, | |
| dispersion particle diameter: 0.15 μm) | |
| Anionic surfactant (Neogen SC, produced by | 1.5 parts by mass |
| Daiichi Kogyo Seiyaku Co., Ltd.) | |
| Nonionic surfactant (Nonipol 400, | 0.5 parts by mass |
| produced by Sanyo Chemical Industries Ltd.) | |
| Ion exchanged water | 1530.0 parts by mass |

The above materials were dispersed in a flask and heating was started under substitution with nitrogen. When the solution was heated to 65° C., a solution obtained by dissolving 5.9 parts by mass of potassium persulfate in 300.0 parts by mass of ion exchanged water was added to the solution. While maintaining the solution temperature to be 65° C., the monomer mixture B was added and stirred, and emulsion reaction was continued for 8 hours by raising the resulting solution temperature to 75° C. Thereafter, the resulting solution was cooled to 40° C. and then filtered with a filter to prepare a dispersion solution B.

### Dispersion Solution C:

| | |
|---|---|
| C.I. Pigment Blue 15:3 | 12.0 parts by mass |
| Anionic surfactant (Neogen SC, produced by | 2.0 parts by mass |
| Daiichi Kogyo Seiyaku Co., Ltd.) | |
| Ion exchanged water | 78.0 parts by mass |

The above materials were mixed and then dispersed by means of a sand grinder mill to prepare a colorant dispersion solution C.

In a 1 liter separable flask equipped with a stirring device, a cooling tube and a thermometer, 300.0 parts by mass of the dispersion solution A, 150.0 parts by mass of the dispersion solution B and 25.0 parts by mass of the dispersion solution C were placed and stirred. To the mixed solution, 180.0 parts by mass of a 10% by weight sodium chloride aqueous solution was dropwise added as a coagulant, and the resulting solution was heated to 54° C. and the temperature was maintained for one hour while stirring the contents of the flask in an heating oil bath.

In the subsequent fusion step, into the flask, 3.0 parts by mass of an anionic surfactant (Neogen SC, produced by Daiichi Kogyo Seiyaku Co., Ltd.) was further added. Thereafter, the stainless steel flask was sealed tightly and was heated to 100° C. with stirring using a magnetic seal. The temperature was maintained for 3 hours. Then, after cooling, the reaction product was filtered and sufficiently washed with ion exchanged water, followed by drying to produce toner particles.

A toner 5 was obtained by externally mixing 1.0 part by mass of titanium oxide fine powder having a number average particle size of 40 nm treated with i-butyltrimethoxysilane to have a hydrophobicity degree of 50%, and 0.5 parts by mass of amorphous silica fine powders having a number average particle size of 110 nm treated with hexamethyldisilazane to have a hydrophobicity degree of 85% as inorganic fine particles with 100.0 parts by mass of the resulting toner particles.

The toner 5 had a weight average molecular weight (Mw) of 870,000, a number average molecular weight (Mn) of 8000 and a peak molecular weight (Mp) of 19,000, as determined by GPC.

The physical properties of the toners 1 to 5 are shown in Table 3.

TABLE 3

| | | Average |
|---|---|---|
| | D4 [μm] | circularity |
| Toner 1 | 5.8 | 0.959 |
| Toner 2 | 4.8 | 0.934 |
| Toner 3 | 5.6 | 0.948 |
| Toner 4 | 7.2 | 0.980 |
| Toner 5 | 6.2 | 0.965 |

### Examples 1 to 14 and Comparative Examples 1 to 7

Next, the magnetic carriers and toners thus prepared were combined as shown in Table 4 to prepare two-component developers.

Each of the two-component developers was prepared by mixing 90.0% by mass of a magnetic carrier and 10.0% by mass of a toner for 5 minutes by means of a V-type mixer.

TABLE 4

| | Magnetic carrier | Toner |
|---|---|---|
| Example 1 | Magnetic carrier 1 | Toner 1 |
| Example 2 | Magnetic carrier 1 | Toner 3 |
| Example 3 | Magnetic carrier 1 | Toner 4 |
| Example 4 | Magnetic carrier 1 | Toner 5 |
| Example 5 | Magnetic carrier 2 | Toner 1 |
| Example 6 | Magnetic carrier 3 | Toner 1 |
| Example 7 | Magnetic carrier 4 | Toner 1 |
| Example 8 | Magnetic carrier 5 | Toner 1 |
| Example 9 | Magnetic carrier 6 | Toner 1 |
| Example 10 | Magnetic carrier 7 | Toner 1 |
| Example 11 | Magnetic carrier 8 | Toner 1 |
| Example 12 | Magnetic carrier 9 | Toner 1 |
| Example 13 | Magnetic carrier 10 | Toner 1 |
| Example 14 | Magnetic carrier 11 | Toner 1 |
| Comparative | Magnetic carrier 12 | Toner 1 |
| Example 1 | | |
| Comparative | Magnetic carrier 13 | Toner 1 |
| Example 2 | | |
| Comparative | Magnetic carrier 13 | Toner 2 |
| Example 3 | | |
| Comparative | Magnetic carrier 14 | Toner 1 |
| Example 4 | | |
| Comparative | Magnetic carrier 15 | Toner 1 |
| Example 5 | | |
| Comparative | Magnetic carrier 16 | Toner 1 |
| Example 6 | | |
| Comparative | Magnetic carrier 17 | Toner 1 |
| Example 7 | | |

As an image forming apparatus, a modified copier of a color copier iRC 3380 manufactured by Canon Inc. was used. The color copier was modified such that the rotation direction of the developer carrying member is in a forward direction to the development area of the drum. The following evaluations were carried out by placing the developer in the developing unit at the cyan position. The development condition was modified such that the circumferential velocity of the developer carrying member is 1.5 times as fast as that of the photosensitive member. A frequency of 1.9 kH, an alternating voltage having a peak-to-peak voltage (Vpp 1.0 kV) and a direct voltage V_{DC} were applied to the developer carrying member. The direct voltage V_{DC} was adjusted so that the amount of toner laid on paper in an FHH image (solid portion) is 0.5 mg/cm².

Thereafter, evaluations were made at the initial stage and after printing 50,000 sheets in an image ratio of 1% in each environment.

The FFH image is a value representing 256 gradations in hexadecimal number, where 00H is defined as the first gradation (white background portion) and FFH is defined as the 256th gradation (solid portion).

### Printing Environment

Temperature of 23° C./Humidity of 50% RH (hereinafter, N/N)

Temperature of 23° C./Humidity of 5% RH (hereinafter, N/L)

Temperature of 30° C./Humidity of 80% RH (hereinafter, H/H)

### Paper

Color laser copier paper (A4, 81.4 g/m²) (sold by Canon Marketing Japan Inc.)

<Fogging after being Allowed to Stand>

The FFH image was printed on 10 sheets in an image ratio of 5% in each environment.

After the image forming apparatus body was allowed to stand for one week in each environment, 00H image was printed on one sheet.

The average reflectance Dr (%) of the paper was measured with a reflectometer (“REFLECTOMETER MODEL TC-6DS”, manufactured by Tokyo Denshoku CO., LTD.).

The reflectance Ds (%) of the OOH image was measured.

The fogging rate (%) was calculated using the following expression. The resulting fogging was evaluated according to the following criteria.

Fogging rate (%)=Ds(%)−Dr(%)
A: 0.5% or less (Excellent)
B: 0.6% or more and 1.0% or less (Good)
C: 1.1% or more and 2.0% or less (Acceptable level in the present invention)
D: 2.1% or more (Unacceptable level in the present invention)

<Coarseness>

The FFH image was printed on 10 sheets in an image ratio of 5% in each environment.

Subsequently, a dot image (FFT image) in which one pixel was composed of one dot was formed. The spot diameter of the laser beam was adjusted so that the area per one dot on the paper is 20,000 μm2 or more and 25,000 μm² or less. The areas of 1000 dots were measured by using a digital microscope VHX-500 (wide-range zoom lens VH-Z100 manufactured by Keyence Corporation). The number average (S) of the dot areas and the standard deviation (σ) of the dot areas were calculated, and coarseness was calculated from the following expression.

Coarseness Index (I)=σ/S×100
A: I is 4.0 or less (Excellent)
B: I is 4.1 or more and 6.0 or less (Good)
C: I is 6.1 or more and 8.0 or less (Acceptable level in the present invention)
D: I is 8.1 or more (Unacceptable level in the present invention)

<Developability>

An alternating voltage in which a direct voltage V_{DC} was fixed at 300V and Vpp was changed from 0.7 kV to 2.0 kV in increments of 0.1 kV and a direct voltage V_{DC} were applied. The Vpp in which the amount of toner laid on paper was 0.50 mg/cm was determined.
(A) Vpp of 1.3 kV or less (Extremely good)
(B) Vpp of 1.4 kV or more and 1.5 kV or less (Good)
(C) Vpp of 1.6 kV or more and 1.8 kV or less (Acceptable level in the present invention)
(D) Vpp of 1.9 or more (Unacceptable level in the present invention)

<Blank Areas>

The FFH image was printed on 10 sheets at an image ratio of 5% in each environment.

A chart was output in which a horizontal transverse band of the 30H image (a width of 10 mm) and a horizontal band of the FFH image (a width of 10 mm) were alternately disposed to the paper feed direction. The image was read out with a scanner and was binarized. The brightness distribution (256 gradations) of a line in the feed direction of the binarized image is determined, where a tangent line is drawn to the brightness of the 30H image, and the brightness region (area: the sum of brightness numbers) deviated from the tangent line of the 30H image back-end until the tangent line intersects with the brightness of the FFH image is defined as blank areas.

<Evaluation Criteria>
A: 50 or less (excellent)
B: 51 or more and 150 or less (Good)
C: 151 or more and 300 or less (Acceptable level in the present invention)
D: 301 or more (Unacceptable level in the present invention)

<Carrier Adhesion>

Thereafter, the OOH image was printed, and sampling was done by adhering a transparent adhesive tape onto the portion of the photosensitive drum. The number of adhered carrier particles per 1 cm² was calculated by counting the number of magnetic carrier particles adhered onto the photosensitive drum per 1 cm×1 cm.
A: 3 particles or less (Excellent)
B: 4 particles or more and 10 particles or less (Good)
C: 11 particles or more and 20 particles or less (Acceptable level in the present invention)
D: 21 particles or more (Unacceptable level in the present invention)

TABLE 5
Evaluation Results in N/N Environment

| | Initial stage | | | | | | | | | | After 50,000 sheets printing | | | | | | | | | |
|---|---|---|---|---|---|---|---|---|---|---|---|---|---|---|---|---|---|---|---|---|
| | Fogging | | | | | | | | | | Fogging | | | | | | | | | |
| | after | | | | | | | | | | after | | | | | | | | | |
| | allowed | | | | | | Blank | | Carrier | | allowed | | | | | | | | Carrier | |
| | to stand | | Coarseness | | Developability | | areas | | adhesion | | to stand | | Coarseness | | Developability | | Blank areas | | adhesion | |
| Ex. 1 | A | 0.1 | A | 2.9 | A | 1.1 | A | 22 | A | 0 | A | 0.2 | A | 3.2 | A | 1.2 | A | 25 | A | 2 |
| Ex. 2 | A | 0.1 | A | 3.2 | A | 1.1 | A | 22 | A | 0 | A | 0.2 | A | 3.4 | A | 1.2 | A | 23 | A | 2 |
| Ex. 3 | A | 0.1 | A | 3.0 | A | 1.0 | A | 23 | A | 0 | A | 0.2 | A | 3.1 | A | 1.1 | A | 25 | A | 2 |
| Ex. 4 | A | 0.1 | A | 3.1 | A | 1.0 | A | 25 | A | 0 | A | 0.2 | A | 3.2 | A | 1.2 | A | 27 | A | 2 |
| Ex. 5 | A | 0.2 | A | 2.9 | A | 1.1 | A | 29 | A | 0 | A | 0.2 | A | 3.0 | A | 1.2 | A | 33 | A | 1 |
| Ex. 6 | A | 0.2 | A | 3.2 | A | 1.1 | A | 26 | A | 0 | A | 0.2 | A | 3.1 | A | 1.2 | A | 29 | A | 1 |
| Ex. 7 | A | 0.2 | A | 3.3 | A | 1.1 | A | 26 | A | 0 | A | 0.2 | A | 3.4 | A | 1.2 | A | 28 | A | 1 |
| Ex. 8 | A | 0.1 | A | 3.0 | A | 1.2 | A | 28 | A | 0 | A | 0.1 | A | 3.3 | A | 1.3 | A | 31 | A | 0 |
| Ex. 9 | A | 0.2 | A | 3.1 | A | 1.2 | A | 30 | A | 0 | A | 0.2 | A | 3.2 | A | 1.3 | A | 32 | A | 1 |
| Ex. 10 | A | 0.2 | A | 3.4 | A | 1.3 | A | 32 | A | 0 | A | 0.3 | A | 3.4 | A | 1.3 | A | 35 | A | 1 |
| Ex. 11 | A | 0.3 | A | 3.6 | A | 1.3 | A | 33 | A | 0 | A | 0.4 | A | 3.8 | A | 1.3 | A | 34 | A | 1 |
| Ex. 12 | A | 0.1 | A | 3.1 | A | 1.3 | A | 32 | A | 0 | A | 0.2 | A | 3.6 | A | 1.3 | A | 36 | A | 3 |
| Ex. 13 | A | 0.2 | A | 3.3 | A | 1.3 | A | 36 | A | 0 | A | 0.2 | A | 3.9 | A | 1.3 | A | 39 | A | 1 |
| Ex. 14 | A | 0.2 | A | 3.1 | A | 1.3 | A | 36 | A | 0 | A | 0.5 | A | 3.7 | A | 1.3 | A | 38 | B | 5 |
| Com. Ex. 1 | A | 0.4 | A | 3.4 | A | 1.3 | A | 40 | A | 0 | B | 0.8 | A | 3.8 | A | 1.3 | A | 43 | C | 12 |
| Com. Ex. 2 | A | 0.4 | A | 3.6 | A | 1.3 | A | 39 | A | 0 | B | 0.6 | B | 4.8 | B | 1.4 | A | 44 | D | 28 |
| Com. Ex. 3 | A | 0.3 | A | 3.7 | B | 1.4 | A | 40 | A | 0 | B | 0.6 | B | 5.4 | B | 1.4 | A | 48 | D | 42 |
| Com. Ex. 4 | A | 0.5 | A | 3.1 | B | 1.5 | B | 92 | A | 0 | B | 0.9 | A | 3.9 | C | 1.6 | C | 152 | B | 6 |
| Com. Ex. 5 | A | 0.4 | A | 3.9 | B | 1.5 | B | 82 | A | 0 | B | 0.9 | C | 6.9 | C | 1.7 | C | 162 | B | 7 |
| Com. Ex. 6 | A | 0.4 | A | 3.4 | A | 1.3 | A | 39 | A | 0 | B | 0.6 | A | 3.6 | A | 1.3 | A | 49 | C | 11 |
| Com. Ex. 7 | A | 0.4 | A | 3.6 | A | 1.3 | A | 38 | A | 0 | A | 0.5 | B | 5.2 | A | 1.3 | A | 48 | D | 24 |

TABLE 6
Evaluation Results in N/L Environment

| | Initial stage | | | | | | | | | | After 50,000 sheets printing | | | | | | | | | |
|---|---|---|---|---|---|---|---|---|---|---|---|---|---|---|---|---|---|---|---|---|
| | Fogging | | | | | | | | | | Fogging | | | | | | | | | |
| | after | | | | | | | | | | after | | | | | | | | | |
| | allowed | | | | | | Blank | | Carrier | | allowed | | | | | | Blank | | Carrier | |
| | to stand | | Coarseness | | Developability | | areas | | adhesion | | to stand | | Coarseness | | Developability | | areas | | adhesion | |
| Ex. 1 | A | 0.1 | A | 2.6 | A | 1.3 | A | 30 | A | 0 | A | 0.1 | A | 3.0 | A | 1.3 | A | 37 | A | 2 |
| Ex. 2 | A | 0.1 | A | 2.9 | A | 1.3 | A | 29 | A | 0 | A | 0.1 | A | 3.1 | A | 1.3 | A | 38 | A | 2 |
| Ex. 3 | A | 0.1 | A | 2.7 | A | 1.1 | A | 32 | A | 0 | A | 0.1 | A | 3.0 | A | 1.2 | A | 40 | A | 2 |
| Ex. 4 | A | 0.1 | A | 2.8 | A | 1.2 | A | 34 | A | 0 | A | 0.1 | A | 3.1 | A | 1.2 | A | 41 | A | 2 |
| Ex. 5 | A | 0.0 | A | 2.6 | A | 1.3 | A | 39 | A | 0 | A | 0.1 | A | 2.8 | A | 1.3 | A | 47 | A | 1 |
| Ex. 6 | A | 0.1 | A | 2.9 | A | 1.2 | A | 38 | A | 0 | A | 0.1 | A | 3.1 | A | 1.2 | A | 48 | A | 1 |
| Ex. 7 | A | 0.0 | A | 3.1 | A | 1.2 | A | 35 | A | 0 | A | 0.1 | A | 3.2 | A | 1.2 | A | 45 | A | 1 |
| Ex. 8 | A | 0.1 | A | 2.8 | A | 1.3 | A | 38 | A | 0 | A | 0.1 | A | 3.1 | A | 1.3 | A | 42 | A | 1 |
| Ex. 9 | A | 0.1 | A | 2.7 | A | 1.3 | A | 42 | A | 0 | A | 0.1 | A | 3.0 | A | 1.3 | A | 47 | A | 1 |
| Ex. 10 | A | 0.1 | A | 3.0 | A | 1.3 | A | 46 | A | 0 | A | 0.1 | A | 3.2 | B | 1.4 | B | 61 | A | 2 |
| Ex. 11 | A | 0.1 | A | 3.2 | B | 1.4 | B | 52 | A | 0 | A | 0.1 | A | 3.4 | B | 1.5 | B | 57 | A | 1 |
| Ex. 12 | A | 0.1 | A | 2.8 | A | 1.3 | A | 45 | A | 0 | A | 0.1 | A | 3.1 | A | 1.3 | A | 48 | A | 3 |
| Ex. 13 | A | 0.2 | A | 3.1 | B | 1.4 | B | 54 | A | 0 | A | 0.2 | A | 3.4 | B | 1.5 | B | 85 | A | 1 |
| Ex. 14 | A | 0.1 | A | 2.9 | B | 1.4 | B | 57 | A | 0 | A | 0.1 | A | 3.3 | B | 1.4 | B | 98 | B | 7 |
| Com. Ex. 1 | A | 0.2 | A | 3.1 | B | 1.5 | B | 61 | A | 0 | A | 0.3 | A | 3.6 | B | 1.5 | B | 108 | C | 13 |
| Com. Ex. 2 | A | 0.2 | A | 3.4 | B | 1.5 | B | 68 | A | 0 | A | 0.3 | A | 3.9 | C | 1.6 | B | 110 | D | 22 |
| Com. Ex. 3 | A | 0.2 | A | 3.5 | B | 1.5 | B | 75 | A | 0 | A | 0.3 | A | 3.8 | C | 1.7 | B | 125 | D | 38 |
| Com. Ex. 4 | A | 0.2 | A | 3.2 | C | 1.6 | C | 162 | A | 0 | A | 0.3 | A | 3.5 | C | 1.8 | C | 194 | B | 7 |
| Com. Ex. 5 | A | 0.1 | A | 3.7 | C | 1.7 | C | 184 | A | 0 | A | 0.3 | A | 4.8 | D | 1.9 | D | 320 | B | 7 |
| Com. Ex. 6 | A | 0.1 | A | 3.3 | B | 1.5 | B | 90 | A | 0 | A | 0.3 | A | 3.6 | B | 1.5 | B | 140 | C | 12 |
| Com. Ex. 7 | A | 0.1 | A | 3.5 | B | 1.5 | B | 82 | A | 0 | A | 0.3 | A | 3.8 | B | 1.5 | B | 135 | C | 20 |

TABLE 7
Evaluation Results in H/H Environment

| | Initial stage | | | | | | | | | | After 50,000 sheets printing | | | | | | | | | |
|---|---|---|---|---|---|---|---|---|---|---|---|---|---|---|---|---|---|---|---|---|
| | Fogging | | | | | | | | | | Fogging | | | | | | | | | |
| | after | | | | | | | | | | after | | | | | | | | | |
| | allowed | | | | | | Blank | | Carrier | | allowed | | | | | | Blank | | Carrier | |
| | to stand | | Coarseness | | Developability | | areas | | adhesion | | to stand | | Coarseness | | Developability | | areas | | adhesion | |
| Ex. 1 | A | 0.2 | A | 3.1 | A | 1.0 | A | 21 | A | 0 | A | 0.3 | A | 3.5 | A | 1.1 | A | 23 | A | 1 |
| Ex. 2 | A | 0.2 | A | 3.4 | A | 1.1 | A | 20 | A | 0 | A | 0.3 | A | 3.7 | A | 1.2 | A | 21 | A | 1 |
| Ex. 3 | A | 0.2 | A | 3.1 | A | 0.9 | A | 23 | A | 0 | A | 0.3 | A | 3.4 | A | 1.1 | A | 24 | A | 1 |
| Ex. 4 | A | 0.2 | A | 3.2 | A | 1.0 | A | 25 | A | 0 | A | 0.3 | A | 3.5 | A | 1.1 | A | 26 | A | 1 |
| Ex. 5 | A | 0.2 | A | 2.9 | A | 1.1 | A | 28 | A | 0 | A | 0.3 | A | 3.3 | A | 1.2 | A | 30 | A | 1 |
| Ex. 6 | A | 0.2 | A | 3.0 | A | 1.0 | A | 25 | A | 0 | A | 0.2 | A | 3.4 | A | 1.1 | A | 27 | A | 1 |
| Ex. 7 | A | 0.1 | A | 3.3 | A | 1.0 | A | 26 | A | 0 | A | 0.2 | A | 3.8 | A | 1.1 | A | 27 | A | 3 |
| Ex. 8 | A | 0.2 | A | 3.2 | A | 1.1 | A | 27 | A | 0 | A | 0.2 | A | 3.6 | A | 1.2 | A | 26 | A | 1 |
| Ex. 9 | A | 0.3 | A | 3.1 | A | 1.1 | A | 30 | A | 0 | B | 0.6 | A | 3.5 | A | 1.2 | A | 31 | A | 1 |
| Ex. 10 | A | 0.3 | A | 3.3 | A | 1.2 | A | 32 | A | 0 | B | 0.7 | A | 3.7 | A | 1.3 | B | 33 | A | 2 |
| Ex. 11 | A | 0.3 | A | 3.6 | A | 1.2 | A | 30 | A | 0 | B | 0.7 | B | 4.8 | A | 1.3 | B | 32 | A | 1 |
| Ex. 12 | A | 0.4 | A | 3.2 | A | 1.2 | A | 31 | A | 0 | B | 0.9 | A | 3.9 | A | 1.2 | A | 33 | B | 4 |
| Ex. 13 | B | 0.6 | A | 3.6 | A | 1.2 | A | 35 | A | 0 | C | 1.2 | B | 4.6 | A | 1.3 | A | 37 | A | 2 |
| Ex. 14 | A | 0.5 | A | 3.5 | A | 1.2 | A | 34 | A | 0 | B | 1.0 | B | 4.9 | A | 1.3 | A | 36 | B | 8 |
| Com. Ex. 1 | C | 1.4 | A | 3.9 | A | 1.2 | A | 35 | A | 0 | D | 2.8 | B | 5.2 | A | 1.2 | A | 39 | C | 15 |
| Com. Ex. 2 | C | 1.1 | B | 5.2 | A | 1.2 | A | 36 | A | 0 | D | 2.1 | C | 7.9 | A | 1.3 | A | 38 | D | 26 |
| Com. Ex. 3 | C | 1.2 | C | 6.7 | A | 1.2 | A | 35 | A | 0 | D | 2.2 | D | 9.4 | A | 1.3 | A | 37 | D | 41 |
| Com. Ex. 4 | C | 1.4 | A | 3.8 | A | 1.3 | A | 45 | A | 0 | D | 2.7 | B | 5.4 | B | 1.5 | A | 49 | B | 5 |
| Com. Ex. 5 | C | 1.5 | C | 6.2 | A | 1.3 | A | 47 | A | 0 | D | 2.8 | D | 10.2 | B | 1.5 | A | 48 | B | 7 |
| Com. Ex. 6 | C | 1.3 | A | 3.7 | A | 1.2 | A | 35 | A | 0 | D | 2.7 | A | 3.8 | A | 1.2 | A | 36 | C | 16 |
| Com. Ex. 7 | C | 1.2 | B | 5.4 | A | 1.2 | A | 36 | A | 0 | C | 2.0 | C | 7.1 | A | 1.2 | A | 37 | D | 25 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Laid-Open No. 2008-200642, filed Aug. 4, 2008 which is hereby incorporated by reference herein in its entirety.

What is claimed is:

1. A magnetic carrier comprising magnetic carrier particles comprising at least porous magnetic core particles and a resin, wherein
in a mercury intrusion method applied to the porous magnetic core particles, a pore diameter in which a differential pore volume in a pore diameter range of 0.10 μm or more and 3.00 μm or less is maximum is from 0.80 μm or more and 1.5 μm or less, and
where a maximum value of a differential pore volume in a pore diameter range of 0.80 μm or more and 1.50 μm or less is defined as P1 and a maximum value of a differential pore volume in a pore diameter range of 2.00 μm or more and 3.00 μm or less is defined as P2, P1 is 0.05 ml/g or more and 0.50 ml/g or less and a ratio P2/P1 is 0.05 or more and 0.30 or less.

2. The magnetic carrier according to claim 1, wherein electric field intensity immediately before breakdown of the porous magnetic core particles is 400 V/cm or more and 2000 V/cm or less.

3. The magnetic carrier according to claim 1, wherein the resin contains at least a silicone resin.

4. The magnetic carrier according to claim 1, wherein the surface of the magnetic carrier is further coated with a resin.

5. A two-component developer comprising a magnetic carrier and a toner, wherein the magnetic carrier is a magnetic carrier according to claim 1.

6. The two-component developer according to claim 5, wherein, when circularities of the toner are measured with a flow-type particle image analyzer having an image processing resolution of 512×512 pixels (0.37 μm×0.37 μm per pixel) and the circularities thus measured in a range of 0.200 or more and 1.000 or less are divided into 800 and analyzed, an average circularity of the toner having a circle-equivalent diameter of 1.985 μm or more and less than 39.69 μm has is 0.940 or more and 1.000 or less.
